(19) United States
(12) Patent Application Publication
(10) Pub. No.: US 2012/0237236 A1
(43) Pub. Date: Sep. 20, 2012

(54) IMAGE FORMING APPARATUS AND IMAGE FORMING METHOD

(75) Inventor: Yohei NAKADE, Okazaki-shi (JP)

(73) Assignee: Konica Minolta Business Technologies, Inc., Chiyoda-ku (JP)

(21) Appl. No.: 13/415,147

(22) Filed: Mar. 8, 2012

(30) Foreign Application Priority Data
Mar. 15, 2011 (JP) 2011-056891

(51) Int. Cl. G03G 13/06; G03G 15/06

(52) U.S. Cl. 399/55

(57) ABSTRACT

Image forming apparatus to expose-scan electrically charged surface of image carrier based on image data in unit of page to form electrostatic latent image, and develop electrostatic latent image at development position on image carrier by using developer carried by developer carrier. The image forming apparatus determines, based on image data of page, first and second partial regions having first and second attributes in page, not overlapping in sub scanning direction, and switches development bias voltage value and/or rotational speed of developer carrier to value for first attribute while electrostatic latent image on image carrier corresponding to first partial region passes through development position, and to value for second attribute while electrostatic latent image corresponding to second partial region passes through development position.

This application is based on applications No. 2011-56891 filed in Japan, the contents of which are hereby incorporated by reference.

### BACKGROUND OF THE INVENTION

(1) Field of the Invention

The present invention relates to an image forming apparatus and an image forming method for forming an image on an image carrier.

(2) Related Art

An image forming apparatus, such as a printer, is generally structured to expose-scan an electrically charged surface of an image carrier such as a photosensitive drum by a laser beam or the like modified based on image data to form an electrostatic latent image thereon, and develop the electrostatic latent image at a development position on the photosensitive drum by using developer such as toner carried by a developer carrier such as a developing roller.

For the development, a development bias voltage, which is composed of a DC component and an AC component, the AC component superimposed on the DC component, is applied to the developing roller, and by a potential difference between the photosensitive drum and the developing roller generated by the application of the development bias voltage, the toner moves to portions on the photosensitive drum that have been exposed by the laser beam, and the toner that has moved to the portions attaches to the photosensitive drum, thereby realizing the development.

As a method for using the development bias voltage, Japanese Patent Application Publication No. 2003-140405 discloses a structure in which electrostatic latent images, which correspond to images of a document having a plurality of pages, are formed sequentially in unit of page on the photosensitive drum to print the images, wherein (a) the development bias voltage is kept to a constant value while the whole region, a region extending from the front end to the rear end, of the n^{th} page of electrostatic latent image formed on the photosensitive drum, passes through the development position, and (b) the voltage value (absolute value) of the DC component of the development bias voltage is decreased during what is called a paper interval, namely, for the time period after the rear end of the n^{th} page of electrostatic latent image passes through the development position and before the front end of the next page, the (n+1)^{th} page, of electrostatic latent image reaches the development position.

It is explained that decreasing the voltage value of the DC component during the paper interval has an effect of preventing what is called a development fog from occurring in the paper interval, wherein the development fog is a phenomenon in which some of the toner particles on the developing roller move and attach to the photosensitive drum at the development position.

With the above structure of Japanese Patent Application Publication No. 2003-140405, it may be possible to restrict the occurrence of the development fog in the paper interval, but there is a problem that the development fog may occur in a non-image region (a region to which the toner should not attach) in the page other than an image region (a region to which the toner is expected to attach).

The reason is as follows. As described above, over the whole region of the page, regardless of image or non-image region, the development bias voltage is maintained to a constant value that is higher than a value of the development bias voltage in the page interval. This makes it easier for the development fog to occur in the non-image region in the page than in the paper interval even if the development fog can be restricted in the page interval.

When the development fog occurs in the non-image region, the toner particles that have attached thereby to a portion of the photosensitive drum corresponding to the non-image region are transferred onto a recording sheet at a transfer position, which means that the toner is present on the original surface (white) portion of the recording sheet on which the toner should not be present. This decreases the reproducibility of the image on the original surface portion, leading to a degradation of the image quality.

Also, an image of one page includes partial regions of different attributes, such as attribute “thin line” for partial regions of characters or attribute “solid” for partial regions of photographs. Accordingly, with the structure of Japanese Patent Application Publication No. 2003-140405 in which the development bias voltage is kept to a constant value in the whole region of the page, the characters may have high density and the reproducibility of thin lines may be decreased if the development bias voltage is set to improve the reproducibility of the density in the solid regions, or, conversely, the solid regions may have low density and the reproducibility of solid regions may be decreased if the development bias voltage is set to improve the reproducibility of thin lines constituting the characters, either case leading to a degradation of the image quality.

### SUMMARY OF THE INVENTION

It is therefore an object of the present invention to provide an image forming apparatus and an image forming method which improve the image quality of the reproduced images.

The above object is fulfilled by an image forming apparatus to expose-scan an electrically charged surface of an image carrier in accordance with image data in unit of page to form an electrostatic latent image on the image carrier, and develop the electrostatic latent image at a development position on the image carrier by using developer carried by a developer carrier, the image forming apparatus comprising: a drive unit driving the developer carrier to rotate; a power source supplying a development bias voltage including a DC component and an AC component to the developer carrier; a determination unit determining, in accordance with image data of a page, a first partial region having a first attribute and a second partial region having a second attribute, the first and second partial regions being included in the page and not overlapping with each other in a sub scanning direction; and a controller switching at least one of a development bias voltage value and a rotational speed of the developer carrier to a value for the first attribute while a portion of an electrostatic latent image of the page formed on the image carrier corresponding to the first partial region passes through a development position, and to a value for the second attribute while a portion of the electrostatic latent image of the page formed on the image carrier corresponding to the second partial region passes through the development position, the value for the first attribute and the value for the second attribute being different values.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 illustrates an overall structure of a printer;

FIG. 2 is a block diagram illustrating the structure of a controller provided in the printer;

FIG. 3 is a flowchart of the process for setting the development bias voltage and the developing roller rotational speed;

FIG. 4 is a flowchart of a subroutine to perform the image region detection process;

FIG. 5A schematically illustrates a graph indicating the potential of the electrostatic latent image corresponding to an image region (solid portion) formed on the photosensitive drum Y, and how the toner particles move to the solid portion;

FIG. 5B schematically illustrates a graph indicating the potential of the electrostatic latent image corresponding to an image region (thin line portion of character), and how the toner particles move to the thin line portion;

FIG. 6 illustrate a flowchart of a part of a subroutine to perform the attribute region determination process;

FIG. 7 illustrate a flowchart of the remaining part of the subroutine to perform the attribute region determination process;

FIG. 8 is a schematic illustration of the image data of page 1 expanded as a bit map in the image memory, in a case where four image regions 1 through 4 are detected in the region of page 1 composed of the whole pixels;

FIG. 9 is a flowchart of a subroutine to perform the development bias setting process;

FIG. 10 illustrates an example of the waveforms in the AC voltage in the development bias voltage;

FIG. 11 is a flowchart of a subroutine to perform the developing roller rotational speed setting process;

FIG. 12 is a timing chart illustrating how the controller controls the development bias voltage and developing roller rotational speed for the color Y during an execution of a print job; and

FIG. 13 illustrates an example of results of evaluation of reproduced images obtained through an experiment of execution of a print job in apparatuses in which a program for performing a control to change the development conditions in units of partial regions had been embedded.

### DESCRIPTION OF PREFERRED EMBODIMENTS

The following describes an embodiment of the image forming apparatus of the present invention, taking a tandem color digital printer (hereinafter, merely referred to as a printer) as an example.

### (1) Overall Structure of Printer

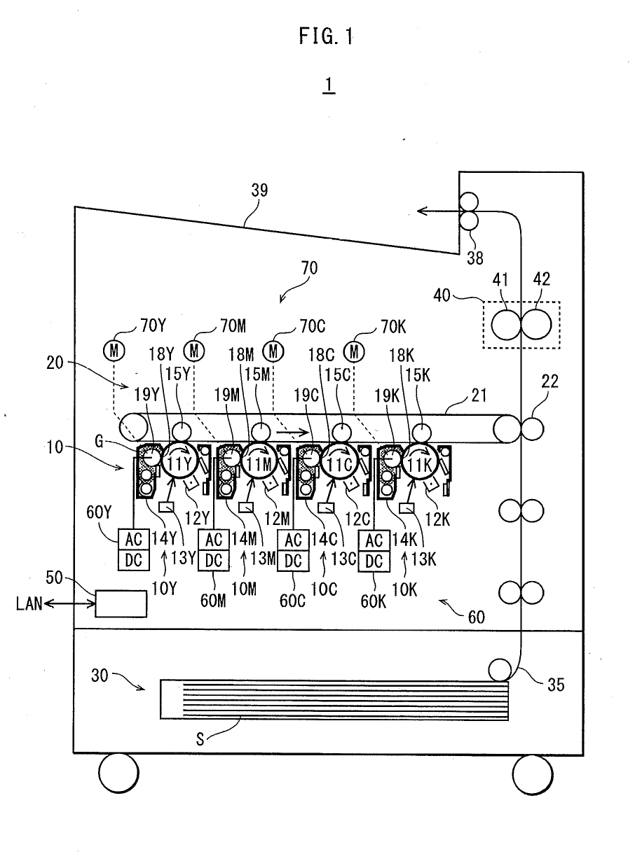

FIG. 1 illustrates an overall structure of a printer 1.

As shown in FIG. 1, the printer 1 is structured to form images by a well-known electrophotographic method, and includes an image forming unit 10, an intermediate transfer unit 20, a feeder 30, a fixing unit 40, a controller 50, a development bias power source unit 60, and a developing roller rotational drive unit 70. Upon receiving a request to execute a print job from an external terminal device (not illustrated) via a network (for example, a LAN), the printer 1 executes a color image formation to form a color image using colors yellow (Y), magenta (M), cyan (C), and black (K) according to the received job request.

The image forming unit 10 includes image creating units 10Y, 10M, 10C, and 10K corresponding respectively to colors of yellow (Y), magenta (M), cyan (C), and black (K). The image creating unit 10Y includes a photosensitive drum 11Y as one example of an image carrier, and also a charger 12Y, an exposing unit 13Y, a developing unit 14Y, a first transfer roller 15Y, and a cleaner for cleaning the photosensitive drum 11Y that are placed in the vicinity of the photosensitive drum 11Y.

The charger 12Y electrically charges the circumferential surface of the photosensitive drum 11Y which rotates in the direction indicated by the arrow. In this example, the charge polarity is set to a minus polarity.

The exposing unit 13Y forms an electrostatic latent image on the photosensitive drum 11Y using a laser beam from a laser diode to expose-scan the charged photosensitive drum 11Y in a main scanning direction.

The developing unit 14Y develops the electrostatic latent image on the photosensitive drum 11Y at a developing position 18Y on the photosensitive drum 11Y by using a developer G carried by a developing roller 19Y which is, as one example of a developer carrier, arranged to face the photosensitive drum 11Y. A developer used in this example is a two-component developer that is composed of: a carrier having a plus charge polarity; and a toner having a minus charge polarity. The development is realized when the toner moves and attaches to exposed portions on the photosensitive drum 11Y, and a toner image of color Y is created on the photosensitive drum 11Y.

The first transfer roller 15Y causes the toner image of color Y to be transferred from the photosensitive drum 11Y onto the intermediate transfer belt 21 of the intermediate transfer unit 20 by the electrostatic action at a transfer position on the photosensitive drum 11Y. Each of the other image creating units 10M through 10K has the same structure as the image creating unit 10Y.

The intermediate transfer belt 21, an endless belt made of a resin such as polyimide, is suspended with tension between a drive roller and a passive roller and is caused by the drive force of the drive roller to move cyclically in the direction indicated by the arrows in the drawing.

The image creating units 10Y through 10K create toner images of respective colors corresponding to the photosensitive drums 11Y through 11K, and each of the created toner images is transferred onto the intermediate transfer belt 21. In this image creation of colors Y through K, the toner images of these colors are transferred at timings that are shifted in order from the upstream side to the downstream side so that the toner images are superimposed at the same position on the intermediate transfer belt 21 which is moving cyclically, the transfer of images performed here being referred to as a first transfer.

The feeder 30 feeds sheets S one by one from the paper feed cassette at timings corresponding to the above image creations in the image forming unit 10 so that the sheets S are transported in the transport path 35 to the second transfer roller 22.

The toner images of respective colors formed on the intermediate transfer belt 21 are transferred onto a sheet S in a superimposed fashion by the electrostatic action of the second transfer roller 22 when the sheet S passes through between the second transfer roller 22 and the intermediate transfer belt 21, the transfer of images performed here being referred to as a second transfer.

The sheet S on which the toner images of the respective colors have been transferred by the second transfer is transported to the fixing unit 40, in which the sheet S is heated and receives a pressure when the sheet S passes through between a fixing roller 41 and a pressing roller 41 of the fixing unit 40, thereby the toner on the surface of the sheet S melts to be fixed to the surface, and then the sheet S is ejected onto a tray 39 by a paper ejecting roller 38.

The development bias power source unit 60 supplies development bias voltages for development to the developing rollers 19Y through 19K of the developers 14Y through 14K, and includes power source units 60Y through 60K that correspond to the respective image creating units. The power source units 60Y through 60K output respective development bias voltages, each of which is a voltage composed of a DC component and an AC component, with the AC component being superimposed on the DC component.

When the respective development bias voltages are applied to the developing rollers 19Y through 19K, a predetermined electrical potential difference occurs between each of the developing rollers 19Y through 19K and each of the photosensitive drums 11Y through 11K at each of developing positions 18Y through 18K, wherein the predetermined electrical potential difference is necessary for the development.

In each of the respective development bias voltages for the colors of Y through K, a voltage value of the DC component is, for example, −500 V, a frequency of the AC component is, for example, 5 kHz, and the AC waveform is, for example, a rectangular wave.

Upon receiving an instruction from the controller 50, the power source units 60Y through 60K switch respective values of the DC voltage of the development bias voltage, and the duty ratio and the peak-to-peak voltage in one cycle of the AC component of the development bias voltage, to different values.

The developing roller rotational drive unit 70 supplies a drive force for driving the developing rollers 19Y-19K, and includes drive units 70Y-70K that correspond to respective image creating units. The drive units 70Y-70K are realized by motors or gear drive mechanisms, and under the instruction by the controller 50, control the rotation/stop and rotational speed of the developing rollers 19Y-19K.

### (2) Structure of Controller 50

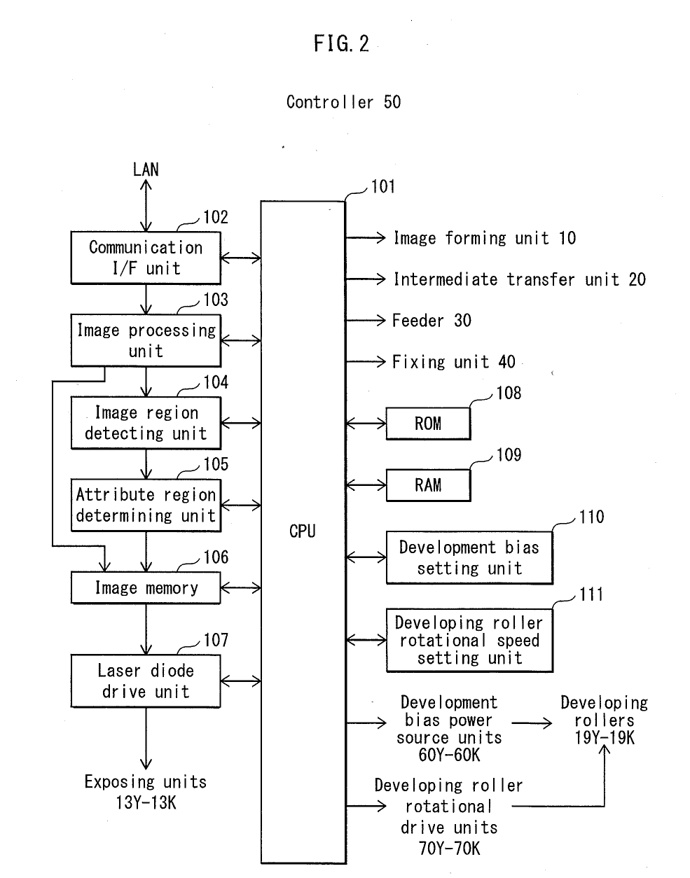

FIG. 2 is a block diagram illustrating the structure of the controller 50.

As shown in FIG. 2, the controller 50 includes a CPU 101, a communication interface (I/F) unit 102, an image processing unit 103, an image region detecting unit 104, an attribute region determining unit 105, an image memory 106, a laser diode drive unit 107, a ROM 108, a RAM 109, a development bias setting unit 110, and a developing roller rotational speed setting unit 111 as the main structural elements, wherein the structural elements can transfer signals and data to each other.

The communication I/F unit 102 is an interface, such as a LAN card or a LAN board, for connecting with a network (in this example, a LAN). The communication I/F unit 102 receives data for print job from an external terminal via the LAN and sends the data to the image processing unit 103. Here, a description is given of, as one example, a job to form n images of n pages of document onto n recording sheets S (forming an image of one page of document onto one recording sheet S), wherein n denotes an integer “1” or more.

The image processing unit 103 performs a known density adjustment process onto the data from the communication I/F unit 102 in a unit of one page, converts the data to respective image data of reproduction colors Y, M, C and K, sends the respective image data of reproduction colors Y, M, C and K after conversion to the image memory 106 in units of pages for the image data to be stored in the image memory 106, and sends the same image data to the image region detecting unit 104.

The image region detecting unit 104 detects image regions per page for each of the reproduction colors Y through K, based on the image data from the image processing unit 103. In the present example, character regions and photo regions are the target of detection.

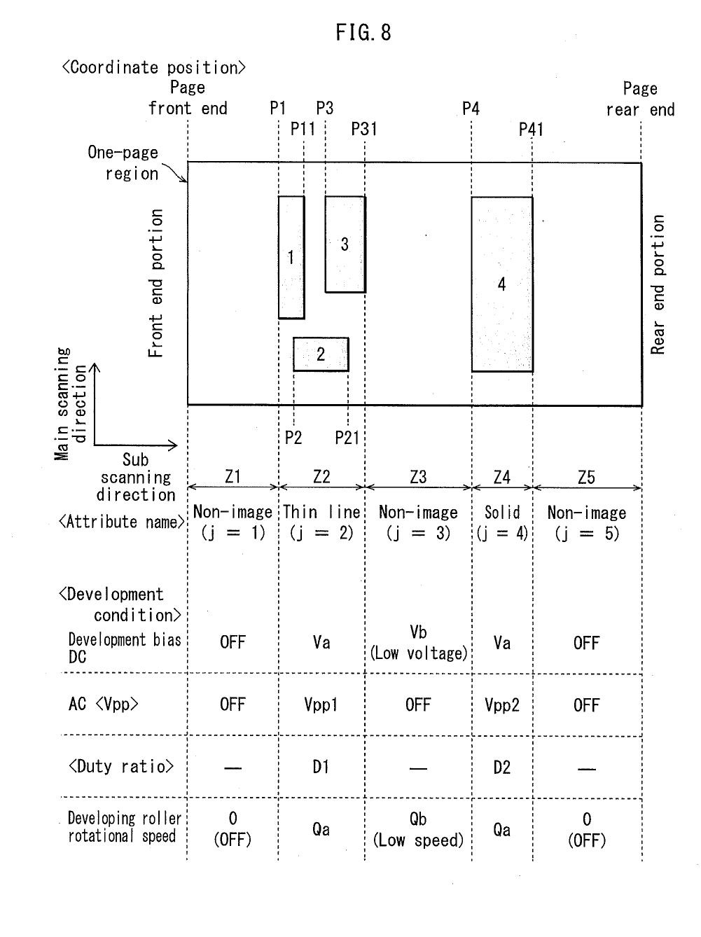

The attribute region determining unit 105 determines, in a unit of one page for each of the reproduction colors Y through K, partial regions (for example, Z1 through Z5 in FIG. 8) of different attributes (thin line, solid, and non-image) that are present in the page at positions not overlapping with each other in the sub scanning direction, based on the detection result of the image region detecting unit 104.

The reason why such partial regions of different attributes in the sub scanning direction are determined is to perform a control, for each partial region, to convert the respective values of the development conditions to values that are suitable for the attributes thereof, wherein the values of the development conditions are the value of the DC component of the development bias voltage, the values of the duty ratio D and peak-to-peak voltage (hereinafter referred to as “Vpp”) per cycle in the AC component of the development bias voltage, and the value of the developing roller rotational speed. The method for this determination will be described later.

The information of the determined attribute regions (setting information) is stored in the image memory 106 in association with, for each of the reproduction colors Y through K, page information indicating page numbers of pages that have been the target of the determination, and the information is read out therefrom when a print job is executed.

The laser diode drive unit 107 reads out the image data of the colors Y through K page by page from the image memory 106 when a print job is executed, and based on the read-out image data, modulate-drives the respective laser diodes of the exposing units 13Y through 13K, thereby causing the laser diodes to emit laser beams. The electrically charged photosensitive drums 11Y through 11K are expose-scanned by the emitted laser beams for the colors Y through K. This causes electrostatic latent images to be formed on the surfaces of the photosensitive drums 11Y through 11K based on the image to be formed.

The CPU 101 reads out a necessary program from the ROM 108, and controls the image forming unit 10, intermediate transfer unit 20, feeder 30, fixing unit 40 and the like to smoothly execute the image forming operation, based on the image data stored in the image memory 106. The RAM 109 is a work area of the CPU 101.

The development bias setting unit 110 sets values of the DC component, duty ratio D and Vpp of the development bias voltage for the case where printing is performed in a unit of one page onto the partial regions of different attributes determined by the attribute region determining unit 105, for each of the reproduction colors Y through K. The method for setting the development bias voltage will be described later.

The developing roller rotational speed setting unit 111 sets values of the developing roller rotational speed for each attribute region when printing is performed in a unit of one page onto the partial regions of different attributes determined by the attribute region determining unit 105 for each of the reproduction colors Y through K. The method for setting the developing roller rotational speed will be described later.

### (3) Setting of Development Bias Voltage and Developing Roller Rotational Speed

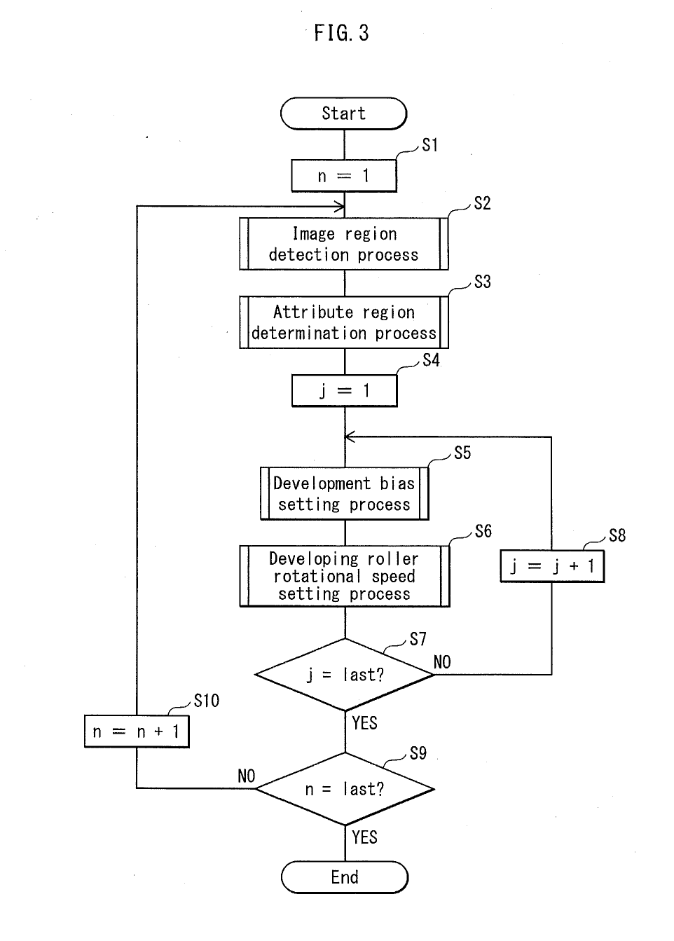

FIG. 3 is a flowchart of the process for setting the development bias voltage and the developing roller rotational speed, the process being executed each time a print job is received. This process is performed independently for each of the reproduction colors Y through K. Since the respective processes for the colors Y through K are basically the same, the following explains the case of color Y as the representative example.

As shown in FIG. 3, variable “n” is set to value “1” (step S1). The value of variable “n” indicates a page number, and equation “n=1” indicates page 1. Next, an image region detection process (step S2) and an attribute region determination process (step S3).

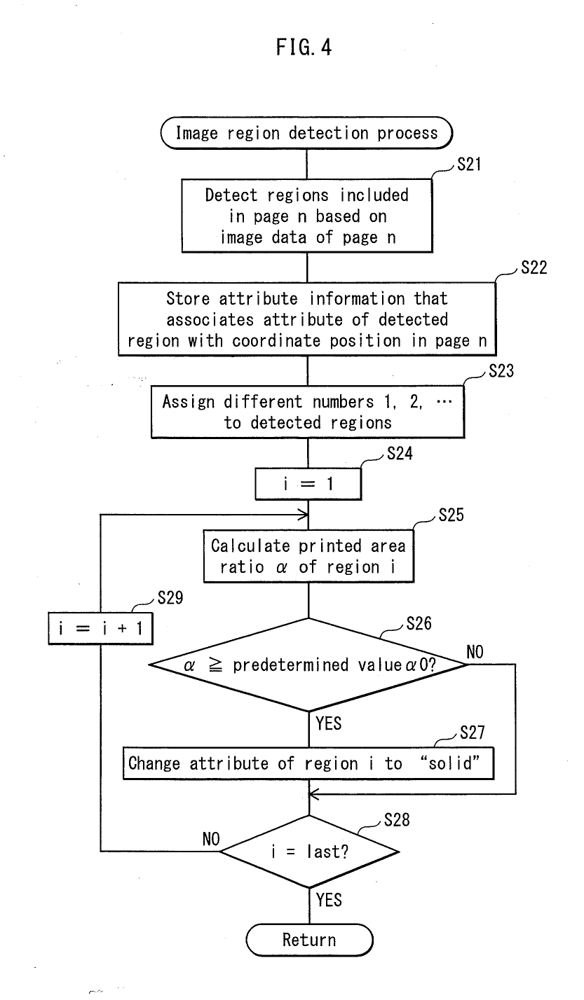

FIG. 4 is a flowchart of a subroutine to perform the image region detection process (step S2) which is performed by the image region detecting unit 104.

As shown in FIG. 4, the image regions included in page n (in this example, 1) are detected based on the image data of page n (in this example, 1, namely image data of one page that is page 1) among the image data of color Y (step S21). Here, character regions and photo regions are the target of detection.

The character regions are detected by, for example, the following method. (a) The image data of page 1 is caused to pass through a known edge filter to generate a binary edge image.

(b) The generated binary edge is caused to pass through a known filter to detect ruled lines, and the detected ruled lines are deleted. The ruled lines are deleted to increase the accuracy in determining characters. (c) In the binary edge image from which the ruled lines have been deleted, blocks that are present in a predetermined range defined by the main and sub scanning directions are linked together, and a rectangular region is set to surround the linked blocks.

(d) Amounts of features of local shapes (for example, the amount of curves, directions of slants, the number of closed loops, the number of cross intersections, and the number of T-shaped intersections) are extracted from the image included in each of the set rectangular regions, and the image of the rectangular region is judged as a character if the number of amounts of features, among the extracted amounts of features, that match feature points included in the patterns for the character determination that are preliminarily held in the apparatus is equal to or greater than a predetermined value (threshold value), and the image of the rectangular region is judged as not a character if the number of amounts of features that match the feature points is smaller than the threshold value. When a plurality of rows of character sequences are present, if a gap between adjacent character sequences is equal to or smaller than a predetermined multiple number of the height of the characters or if the gap is equal to or smaller than a predetermined value, one block that surrounds the whole plurality of rows of character sequences may be set a rectangular region. Note that the character determination may be performed by other methods such as a method for performing a pattern recognition based on a dictionary for the character determination.

On the other hand, photo regions are detected by, for example, the following method. (a) The image data of page 1 is binarized using a predetermined threshold value that is different from the threshold value used in the character determination, the binarized image is linked with pixels, and labeling is performed.

(b) A judgment is made with regard to each block included in each of the labeled images, and if the block satisfies a predetermined condition, the block is judged as a photo region, wherein the predetermined condition is, for example, whether the size of the block is larger than a predetermined size (for example, a size of a character) and a ratio of the number of halftone pixels to the total number of pixels is equal to or higher than a predetermined ratio. Note that photo regions are not limited to regions including photos, but regions including images with gradation such as drawings or charts may be regarded as photo regions as well. With regard to the distinction between character regions and photo regions, a method disclosed in Japanese Patent Application Publication No. 2005-316813 or other methods may be used.

Each time a region is detected in page 1, attribute information is stored, wherein the attribute information associates the attribute of the detected region with coordinate position data of the detected region in the page (step S22). The storing of the attribute information corresponds to temporarily determining the attribute of a character region as “thin line” and the attribute of a photo region as “solid”.

Different numbers 1, 2, . . . are assigned to all regions whose attribute has been temporarily determined as “thin line” (the regions corresponding to character regions) (step S23).

Subsequently, variable “i” is set to value “1” (step S24). The value of variable “i” indicates one of the above-assigned region numbers. Next, in this example, a printed area ratio α of the first region is calculated (step S25). Note that the printed area ratio α is represented as αb/αa, wherein the sign “αa” denotes the whole area of the first region and the sign “αb” denotes the area of the image portions (the portions constituting the lines of the characters) included in the first region.

When the printed area ratio α is high, it means that the ratio of area of characters included in the first region is high. In character regions, if the character is composed of thick lines, the width of the character (width of character line) is large and the printed area ratio α is high compared with the case where the character is composed of thin lines. Taken this into account, it can be said that the printed area ratio α indicates the size of width of character line, as well. Note that the value of area may be replaced with the number of pixels.

It is judged whether or not the calculated printed area ratio α is equal to or higher than a predetermined value α0 (step S26). Note that the predetermined value α0 is a threshold value used to judge whether the character image to be formed is composed of thin lines or others (lines thicker than a line of predetermined thickness), and that the predetermined value α0 is determined for each apparatus through experiment or the like.

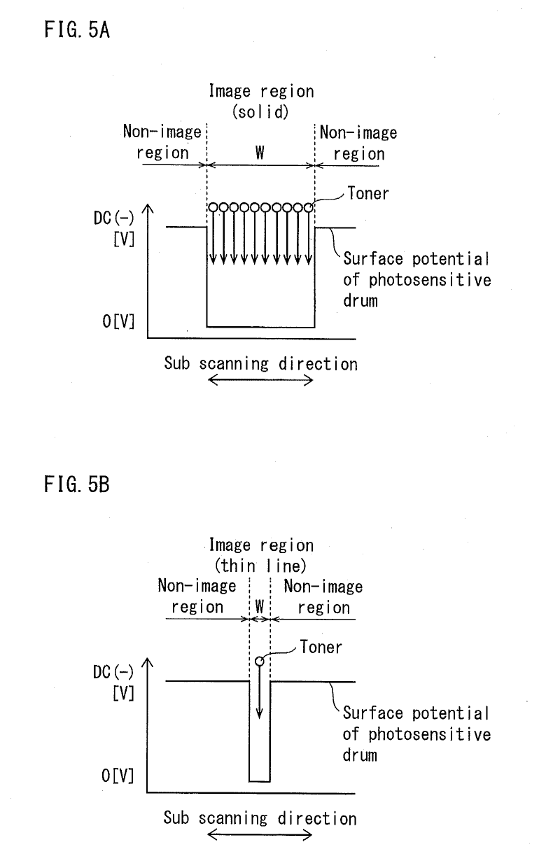

The reason why it is judged whether the character lines included in the first region are thin lines or others is to switch the respective values of the duty ratio and the value Vpp for the first region to different values depending on whether the character lines are thin lines or others. The reason is explained in the following with reference to FIGS. 5A and 5B.

FIG. 5A schematically illustrates a graph indicating the potential of the electrostatic latent image corresponding to the high-density image region (solid portion) formed on the photosensitive drum 11Y, and how the toner particles move to the solid portion. FIG. 5B schematically illustrates a graph indicating the potential of the electrostatic latent image corresponding to the image region (thin line portion of character), and how the toner particles move to the thin line portion.

As shown in FIG. 5A, in a latent image portion (a portion with dropped potential between non-image regions) corresponding to the image region (solid portion) on the photosensitive drum 11Y, width W in the sub scanning direction is relatively large. Thus, when toner particles fly from the developing roller 19Y toward the photosensitive drum 11Y, the particles are likely to attach to the latent image portion that corresponds to the image region (solid portion) on the photosensitive drum 11Y (namely, the particles are likely to enter the portion with the dropped potential).

Also, normally, an edge of an image region is a boundary between itself and a non-image region. Accordingly, at an edge of an image region, the difference in potential drastically changes, and the density of the electric field is high, and thus, affected by the high-density electric field, the movement of the toner particles is more likely to change than at the center in the width direction.

For this reason, for example, the following phenomenon is likely to occur: among the toner particles flying from the developing roller 19Y toward an edge of the latent image portion (image region, solid portion) on the photosensitive drum 11Y, some toner particles are affected by the electric field in the vicinity of the boundary, and are deviated from the direction toward the image region and move to the non-image region on the photosensitive drum 11Y, and then returns to the developing roller 19Y by the difference in potential between the non-image region on the photosensitive drum 11Y and the developing roller 19Y. When such a phenomenon occurs, at the edge of the latent image portion (image region) on the photosensitive drum 11Y, the amount of toner particles to be developed becomes smaller than the original amount and the image region becomes likely to change in density.

Meanwhile, in the solid portion whose width W is relatively large, a more amount of toner particles fly toward the center of the solid portion in the width direction, and some of the particles fly toward the edge of the latent image portion (image region) in the width direction, and before they pass the development position, toner particles are supplemented to the edge of the latent image portion (image region) in the width direction. This stabilizes the image region in density.

On the other hand, as shown in FIG. 5B, in the latent image portion corresponding to the thin line portion on the photosensitive drum 11Y, the width W is very small, and thus toner particles are more difficult to attach to the latent image portion corresponding to the thin line portion on the photosensitive drum 11Y than to the solid portion (toner particles are difficult to gather at the portion with dropped potential).

Also, in the case of a small width W, when, as described above, toner particles flying toward the edge of the latent image portion (image region) are deviated and move to the non-image region, a small amount of toner particles fly toward the thin line portion, and, different from the case of the solid portion, it is unlikely that toner particles are supplemented to the edge of the latent image portion (image region), and it becomes difficult to stabilize the density of the image region.

It is understood from the above observation that developing the thin lines and other portions on the same developing condition is not preferable. In view of this, the present embodiment classifies the attribute of the image region into “thin line” and other than the “thin line” (which is to say, “thin line” and “solid portion” in this example), and converts the values of the development conditions to the values that are suitable for the attribute of the image region, wherein the values of the development conditions are values of the DC component, duty ratio D and Vpp of the development bias voltage.

Even if an image region is determined to be a character region, the attribute of the image region, “thin line” or other than “thin line”, varies depending on the width of the character line. If the width of the character line is large enough to cause the same phenomenon to occur as the solid portion, the attribute of the character region is determined as other than “thin line”. In that case, the development conditions for the solid portion can also be applied to regions that have been determined as character regions.

In view of this, with regard to a region which was once determined as a character region, it is re-judged whether or not its attribute is “thin line”, based on the size of the printed area ratio α. If, by the re-judgment, the attribute of a region is judged not to be “thin line”, the attribute is changed from “thin line” to “solid”.

Back to FIG. 4, if it is judged in step S26 that the calculated printed area ratio α is equal to or higher than the predetermined value α0 (YES in step S26), the attribute of the first region is changed from “thin line” to “solid” (step S27), and the control proceeds to step S28. This change of the attribute is realized by rewriting the data portion of the attribute information, which was stored into the RAM 109 in the above step S22, that indicates the attribute.

If it is judged in step S26 that the calculated printed area ratio α is smaller than the predetermined value α0 (NO in step S26), the control moves to step S28 keeping the attribute as “thin line”.

In step S28, it is judged whether or not the value of variable “i” is the last number. Here, the last number means the last number among the numbers assigned in steps S23. If it is judged that the value of variable “i” is not the last number (NO in step S28), the current value of variable “i” is incremented by “1” to be set to “2” (step S29), and the control returns to step S25. When the value of variable “i” is “2”, the re-judgment process of steps S25 through S28 is performed onto the second region to re-judge whether or not the second region is “thin line”.

The process of steps S25 through S28 is repeatedly executed until it is judged that the value of variable “i” is the last number. When it is judged that the value of variable “i” is the last number (YES in step S28), it is judged that the re-judgment process has been performed onto all the detected character regions, and the control returns to the main routine.

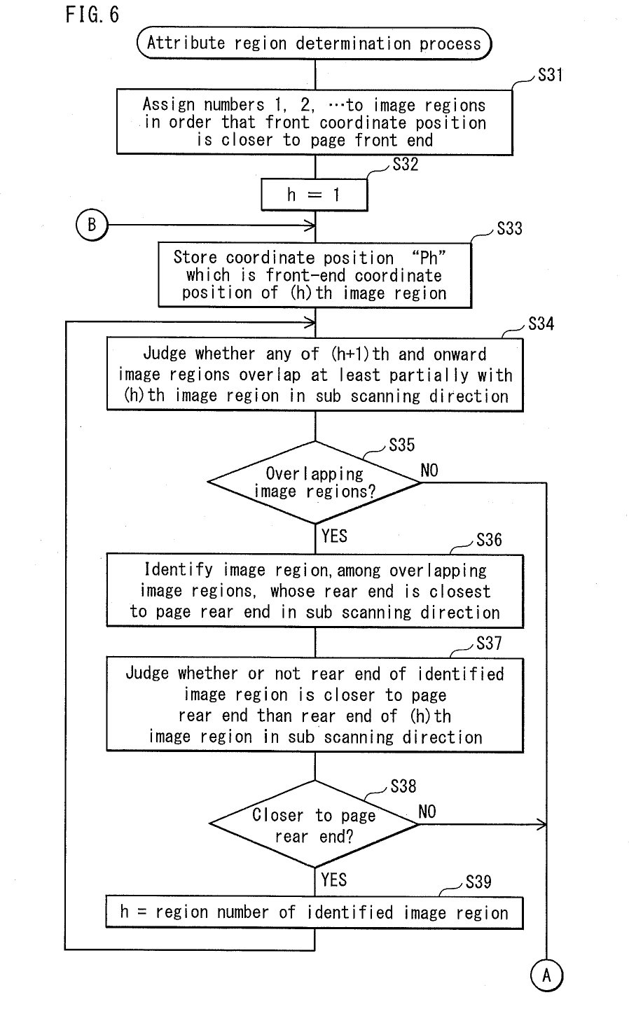

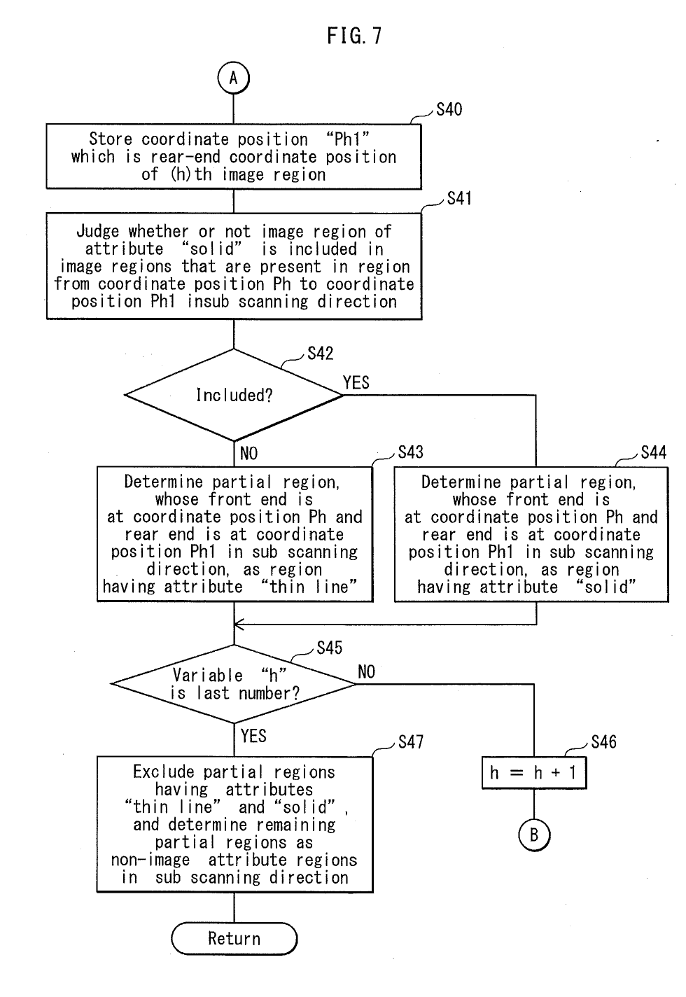

FIGS. 6 and 7 illustrate a flowchart of a subroutine to perform the attribute region determination process (step S3) which is performed by the attribute region determining unit 105.

As shown in FIG. 6, with regard to the respective image regions (“thin line” and “solid” regions) of page 1 that have been detected in the above-described image region detection process, the front coordinate positions are identified, and numbers 1, 2, . . . are assigned to the detected image regions in the order that the front coordinate position is closer to the page front end (step S31).

FIG. 8 is a schematic illustration of the image data of page 1 expanded as a bit map in the image memory 106, in a case where four image regions 1 through 4 are detected in the region of page 1 composed of the whole pixels. It is presumed here that, among the two end portions of the one-page region in the sub scanning direction, an end portion from which the exposure-scan starts is referred to as a “front end portion”, and the opposite end a “rear end portion”, and the front end of the front end portion is referred to as a “page front end”, and the rear end of the rear end portion a “page rear end”.

Also, FIG. 8 illustrates a case where image regions 1 and 2 partially overlap in the sub scanning direction, and image regions 2 and 3 partially overlap in the sub scanning direction, as well.

In FIG. 8, “P1”, “P2”, “P3”, and “P4” denote respective front-end positions of image regions and correspond to respective coordinate positions. For example, the sign P1 represents a position that is closest to the page front end among all positions in the image region 1. Similarly, the signs P2, P3 and P4 represent positions that are closest to the page front end among all positions in the image regions 2, 3 and 4, respectively. As shown in FIG. 8, these image regions 1 through 4 are arranged in the order that the front coordinate position is closer to the page front end, namely, in the order of image regions 1, 2, 3, and 4. As a result, numbers 1, 2, 3, and 4 are assigned to the image regions 1, 2, 3, and 4, respectively.

Back to FIG. 6, in step S32, variable “h” is set to value “1”. The variable “h” is a value indicating one of the numbers 1, 2, 3, and 4 assigned to the image regions in the above step S31.

A coordinate position “Ph” which is the front-end coordinate position of the h^{th} image region (in this example, coordinate position “P1” which is the front-end coordinate position of the image region 1) is stored (step S33).

Next, it is judged whether or not any of the (h+1)^{th} and onward image regions (in this example, image regions 2 through 4) overlap at least partially with the h^{th} image region (in this example, image region 1) in the sub scanning direction (step S34). This judgment is realized by referring to the data of the coordinate positions in the image region 1 and the data of the coordinate positions in the image regions 2 through 4. In the case of the example shown in FIG. 8, it is judged that the image region 2 overlaps with the image region 1 partially in the sub scanning direction.

The reason why it is judged whether or not any of a plurality of existing image regions overlaps at least partially with the target image region in the sub scanning direction is to set an attribute region for switching between development conditions.

More specifically, the development condition can only be changed in units of partial regions in one page that do not overlap with each other in the sub scanning direction. And thus, if a plurality of image regions partially overlap with each other in the sub scanning direction, the development condition cannot be changed in the overlapping parts even if the image regions having the overlapping parts have different attributes. In view of this, in the present embodiment, such a plurality of image regions partially overlap with each other in the sub scanning direction are regarded as one partial region, and a development condition suitable for the one partial region is applied.

If it is judged that there are a plurality of overlapping image regions (YES in step S35), an image region, among the plurality of overlapping image regions, whose rear end is closest to the page rear end in the sub scanning direction is identified (step S36). In the case of the example shown in FIG. 8, it is judged that only the image region 2 overlaps with the image region 1. Thus in this example, the image region 2 is identified in step S36. If it is judged that a plurality of image regions overlap with the image region 1, the rear end coordinate positions of the image regions are compared with each other, and an image region whose rear end is closest to the page rear end in the sub scanning direction is identified. Note that there may be a case where the rear end coordinate positions of a plurality of image regions are the same, and the plurality of image regions are identified as those whose rear end coordinate positions are closest to the page rear end.

Subsequently, it is judged whether or not the rear end of the identified image region is closer to the page rear end than the rear end of the h^{th} image region (in this example, image region 1) in the sub scanning direction (step S37). In the case of the example shown in FIG. 8, sign P21 represents the rear end position of the identified image region 2 in the sub scanning direction, and sign P11 represents the rear end position of the image region 1 in the sub scanning direction, and since position P21 is closer to the page rear end than position P11, it is judged that the rear end of the identified image region is closer to the page rear end than the rear end of the image region 1. If position P11 is closer to the page rear end than position P21, it is judged that the rear end of the identified image region is not closer to the page rear end than the rear end of the image region 1.

If it is judged that the rear end of the identified image region is not closer to the page rear end than the rear end of the image region 1, it means that the image region 2 is present between the front end and the rear end of the image region 1 in the sub scanning direction.

If it is judged that the rear end of the identified image region is not closer to the page rear end than the rear end of the image region 1 (NO in step S38), the control moves to step S40 shown in FIG. 7.

On the other hand, if it is judged that the rear end of the identified image region is closer to the page rear end than the rear end of the image region 1 (YES in step S38), the variable “h” is set to the number of the identified image region (in this example, “2”) (step S39), and the control returns to step S34. In step S34 of the second round, it is judged whether or not any of the (h+1)^{th} and onward image regions (h=2, thus, in this example, image regions 3 through 4) overlap at least partially with the image region h (in this example, image region 2) in the sub scanning direction. In the case of the example shown in FIG. 8, it is judged that the image region 3 overlaps with the image region 2 partially in the sub scanning direction.

If it is judged that there are a plurality of overlapping image regions (YES in step S35), the processes are performed in steps S36 through S38 as described above, and an image region, among the plurality of overlapping image regions, whose rear end is closest to the page rear end in the sub scanning direction is identified, and it is judged whether or not the rear end of the identified image region is closer to the page rear end than the rear end of the image region 2. In the case of the example shown in FIG. 8, the image region 3 is identified, and the rear end of the identified image region 3 is closer to the page rear end than the rear end of the image region 2, and thus it is judged YES in step S38, the variable “h” is set to “3” in step S39, and the control returns to step S34 again.

The process of steps S34 and onward is repeated as described above, an in this round of performance, in the case of the example shown in FIG. 8, the image regions 3 and 4 do not overlap with each other in the sub scanning direction, thus it is judged NO in step S35, and the control moves to step S40 shown in FIG. 7. The process performed up to this indicates that, in the case of the example shown in FIG. 8, image regions 1 through 3 are arranged in positional to overlap partially in the sub scanning direction.

In step S40, a coordinate position “Ph1” which is the rear-end coordinate position of the h^{th} image region for the current value of variable “h” (in this example, coordinate position “P31” which is the rear-end coordinate position of the image region 3) is stored.

It is judged whether or not an image region of attribute “solid” is included in image regions that are present in a region from coordinate position Ph (stored in step S33: in the above example, P1) to coordinate position Ph1 (stored in step S40: in the above example, P31) in the sub scanning direction (step S41). In the case of the example shown in FIG. 8, image regions 1, 2 and 3 are present in the region from coordinate position P1 to coordinate position P31, and if any one of these image regions has attribute “solid”, the judgment result is affirmative.

The reason why it is judged whether or not an image region of attribute “solid” is included is as follows.

That is to say, as described above, in the present embodiment, when there are a plurality of image regions partially overlapping with each other in the sub scanning direction, the overlapping image regions are regarded as one partial region. If the overlapping image regions have the same attribute, a development condition suitable for the attribute can be set. However, if the overlapping image regions have different attributes, either a development condition suitable for “thin line” or a development condition suitable for “solid” needs to be set. If the overlapping image regions have different attributes, it means that the overlapping image regions, which have been regarded as one partial region, include at least one image region whose attribute is “thin line” and at least one image region whose attribute is “solid”. In the present embodiment, in such a case, first preference is given to the attribute “solid”, and a development condition suitable for “solid” is to be set.

The reason why first preference is given to the attribute “solid” is that, as described later, a development condition suitable for “thin line” places greater emphasis on the reproducibility of the thin lines than on the reproducibility of the optical density, and thus, if first preference is given to the attribute “thin line”, there is a fear that the solid portion of the image may be lower in optical density than the original density, and that a decrease in optical density of the solid portion is especially easy to be found by human eyes. When first preference is given to the attribute “solid”, the reproducibility of the thin lines in the characters becomes lower than that in the original image, but compared to the decrease in optical density of the solid portion, a decrease in reproducibility of the thin lines in the characters does not appear as a decreased image quality to the human eyes. Accordingly, this is a result of a comprehensive evaluation of image quality for the whole page in both cases.

If it is judged that an image region of attribute “solid” is not included (NO in step S42), it indicates that only image regions with attribute “thin line” are present in the from coordinate position P1 to coordinate position P31 in the sub scanning direction, and thus a partial region whose front end is at the coordinate position P1 and rear end is at the coordinate position P31 is identified, and the partial region is determined as a region having the attribute “thin line” (step S43), and the control proceeds to step S45. FIG. 8 shows a case where a partial region Z2 in the one page has been determined as a region having the attribute “thin line”.

On the other hand, if it is judged that an image region of attribute “solid” is included (YES in step S42), a partial region whose front end is at the coordinate position P1 and rear end is at the coordinate position P31 is identified, and the partial region is determined as a region having the attribute “solid” (step S44), and the control proceeds to step S45. In this case, the partial region Z2 shown in FIG. 8 is to be determined as a region having the attribute “solid”.

In step S45, it is judged whether or not the value of variable “h” is the last number. Here, the last number means the last number among the numbers assigned in steps S31.

If it is judged that the value of variable “h” is not the last number (NO in step S45), the current value of variable “h”, which is “3” in the above example, is incremented by “1” to be set to “4” (step S46), and the control returns to step S33. In the processes of steps S33 through S39, a coordinate position “P4” which is the front-end coordinate position of the 4^{th} image region (image region 4) is stored, and it is judged whether or not any of the 5^{th} and onward image regions overlaps at least partially with the image region 4, and if it is judged that there are a plurality of overlapping image regions, an image region, among the plurality of overlapping image regions, whose rear end is closest to the page rear end in the sub scanning direction is identified. In the case of the example shown in FIG. 8, only image regions up to the image region 4 are present, thus it is judged NO in step S35, and the control moves to step S40.

In step S40, a coordinate position “P41” which is the rear-end coordinate position of the 4^{th} image region (image region 4) is stored. In step S41, it is judged whether or not an image region of attribute “solid” is included in the region from coordinate position P4 to coordinate position P41 in the sub scanning direction, namely, whether or not the attribute of the image region 4 is “solid”.

If it is judged that the attribute of the image region 4 is “solid” (YES in step S42), a partial region whose front end is at the coordinate position P4 and rear end is at the coordinate position P41 is identified, and the partial region is determined as a region having the attribute “solid” (step S44). FIG. 8 shows a case where a partial region Z4 has been determined as a region having the attribute “solid”. On the other hand, if it is judged that the attribute of the image region 4 is “thin line” (NO in step S42), a partial region whose front end is at the coordinate position P4 and rear end is at the coordinate position P41 is identified, and the partial region is determined as a region having the attribute “thin line” (step S43). In this case, the partial region Z4 shown in FIG. 8 is to be determined as a region having the attribute “thin line”.

The process of steps S33 through S46 is repeatedly executed until it is judged in step S45 that the value of variable “h” is the last number. When it is judged that the value of variable “h” is the last number (YES in step S45), it is judged that the attribute determination process has been performed onto all the image regions included in the one page, and the control moves to step S47.

In step S47, partial regions other than the regions having the attributes “thin line” and “solid” are identified in the one page, the identified partial regions are determined as non-image attribute regions, and the control returns to the main routine. In the case of the example shown in FIG. 8, partial regions having the attribute “non-image” are partial region Z1 extending from the page front end to coordinate position P1, partial region Z3 extending from coordinate position P31 to coordinate position P4, and partial region Z5 extending from coordinate position P41 to the page rear end in the sub scanning direction. Determination of which among “thin line”, “solid”, and “non-image” is the attribute of a region is performed by storing attribute region information that indicates the front-end and rear-end coordinate positions in association with the attribute name for each attribute region.

Back to FIG. 3, in step S4, variable “j” is set to value “1”. The variable “j” is a value indicating one of the numbers 1, 2, . . . assigned in sequence to one or more attribute regions (which are Z1 through Z5 in the example shown in FIG. 8) that are present in one page in the order that the attribute region is closer to the page front end.

In the case of the example shown in FIG. 8, a region (j=1) is a “non-image” partial region, a region (j=2) is a “thin line” partial region, a region (j=3) is a “non-image” partial region, a region (j=4) is a “solid” partial region, and a region (j=5) is a “non-image” partial region. Note that hereinafter attribute regions having the attribute “thin line” or “solid” may be referred to as image regions, and attribute regions having the attribute “non-image” may be referred to as non-image regions.

Subsequently, a development bias setting process (step S5) and a developing roller rotational speed setting process (step S6) are executed.

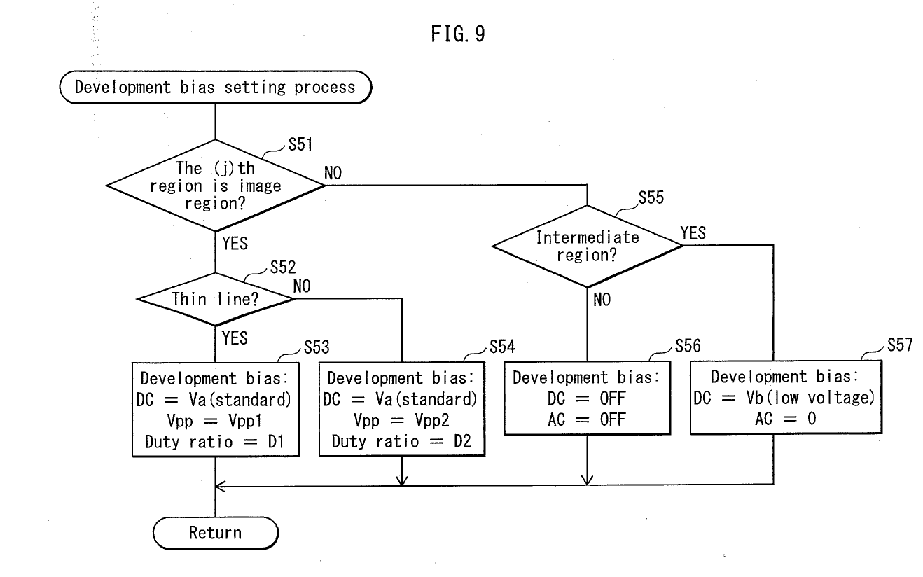

FIG. 9 is a flowchart of a subroutine to perform the development bias setting process.

As shown in FIG. 9, it is judged whether or not the j^{th} partial region, which is, in this example, the first partial region, is an image region (step S51). This judgment is realized by referring to the coordinate positions and the attribute names included in the above-mentioned attribute region information. In the case of the example shown in FIG. 8, the attribute region Z1 (j=1) is “non-image”, and thus it is judged that the j^{th} partial region is not an image region. Here, for the sake of explanation, the case of an image region is explained first, and then the case of a non-image region is explained.

If it is judged that the j^{th} partial region is an image region (YES in step S51), it is judged whether or not the attribute is “thin line” (step S52). If it is judged that the attribute is “thin line” (YES in step S52), the values of the development bias voltage for the first attribute region are set as follows: the DC component is set to Va; the Vpp of the AC component is set to Vpp1; and the duty ratio is set to D1 (step S53), and the control returns to the main routine. It should be noted here that the value “Va” of the DC component is a standard value and the standard value remains the same whether the attribute is “thin line” or “solid”.

With regard to the value “Vpp1” of the AC component and value “D1” of the duty ratio, they are the values suitable for developing images with the attribute “thin line”, and values different from those for “solid” images are set.

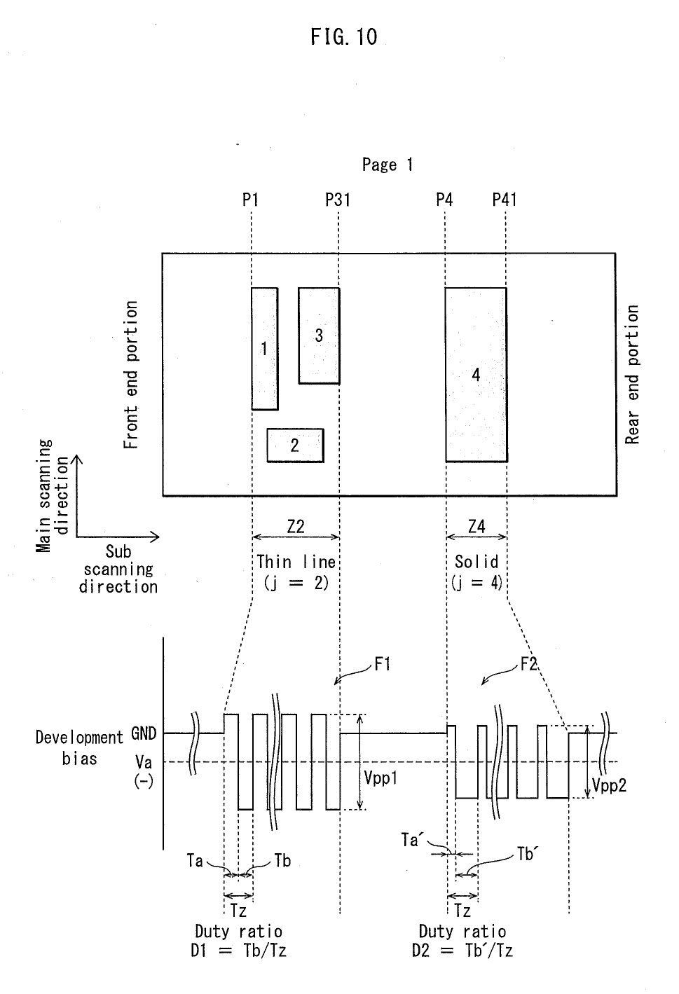

FIG. 10 is a schematic illustration of the waveforms of the AC voltage in the development bias voltage, illustrating a voltage waveform F1 applied to the attribute “thin line” region Z2 and a voltage waveform F2 applied to the attribute “solid” region Z4.

As shown in FIG. 10, the waveforms F1 and F2 have cyclic ups and downs at the same cycle Tz, wherein, in the state where the AC component is superimposed on the DC component, a unit waveform in one cycle Tz is divided into two portions by a DC voltage Va (a minus value) of the DC component: a first potential portion whose potential is closer to the ground in absolute value (in FIG. 10, the portion appearing on the voltage value Va); and a second potential portion whose potential is farther away from the ground (in FIG. 10, the portion appearing under the voltage value Va), a difference between the first potential portion and the second potential portion in peak voltage is a peak-to-peak voltage (Vpp), the time period of the first potential portion in one cycle Tz is Ta, the time period of the second potential portion in the cycle Tz is Tb, and the quotient obtained by dividing the time period Tb by the cycle Tz (=Tb/Tz) is the duty ratio D, and then a peak-to-peak voltage Vpp1 of the waveform F1 is higher than a peak-to-peak voltage Vpp2 of the waveform F2, and a duty ratio D2 of the waveform F2 is higher than a duty ratio D1 of the waveform F1.

The higher the peak-to-peak voltage Vpp, the faster the flying speed of the toner particles when they move between the developing roller 19Y and the photosensitive drum 11Y at a development position 18Y.

On the other hand, as the duty ratio D is higher, in one cycle Tz, the time period during which the potential is on the minus side compared to the ground (GND:0V) is longer than the time period during which the potential is on the plus side. Thus the time taken by the electric field to move the minus toner particles from the developing roller 19Y toward the photosensitive drum 11Y becomes longer than the time taken by the electric field to return the toner particles from the photosensitive drum 11Y to the developing roller 19Y, and the amount of toner supplied to the photosensitive drum 11Y per unit time increases.

To attach a larger amount of toner particles to the latent image portion of a thin line having a short width formed on the photosensitive drum 11Y as shown in FIG. 5B, it is desirable to increase Vpp to increase the flying speed of the toner particles. However, if the duty ratio D is increased in addition to the increase of Vpp, the development fog is likely to occur or the line width is likely to become thicker than the original width, wherein the development fog is a phenomenon in which some toner particles attach to a non-image region (a region to which the toner should not attach) in the page other than the characters. If any of these occurs, the reproducibility is decreased. Thus, conversely, the duty ratio D is preferably decreased.

On the other hand, with regard to the solid regions as shown in FIG. 5A, the duty ratio D is preferably increased to improve the reproducibility of the density in the solid regions. However, if both Vpp and the duty ratio D are increased, the flying speed of the toner particles becomes faster, increasing the amount of supplied toner particles, which causes some toner particles to fly to a non-image region, making it easy for the development fog to occur. Thus, Vpp is preferably decreased.

The waveform F1 shown in FIG. 10 has Vpp and duty ratio D that are suitable for the attribute “thin line”, and the waveform F2 has Vpp and duty ratio D that are suitable for the attribute “solid”, wherein Vpp1 is applied to the attribute “thin line”, and Vpp2 (<Vpp1) is applied to the attribute “solid”, and a duty ratio D1 is applied to the attribute “thin line”, and a duty ratio D2 (>D1) is applied to the attribute “solid”. The values of Vpp and duty ratio D are preliminarily obtained through experiment or the like, and the data is stored in the ROM 108 or the like.

When Vpp or duty ratio D changes, the average value of the development bias voltage changes. Thus, by making Vpp and duty ratio D variable depending on the attribute (“thin line” or “solid”) of the image, the development bias voltage value becomes variable depending on the attribute of the determined partial region.

Back to FIG. 9, if it is judged in step S52 that the attribute is not “thin line”, namely that the attribute is “solid” (NO in step S52), the values of the development bias voltage for the first attribute region are set as follows: the DC component is set to Va (standard), and Vpp and duty ratio D are set to respective values suitable for the attribute “solid”, namely to Vpp2 and D2 (step S54), and the control returns to the main routine.

Also, if it is judged in step S51 that the first partial region is not an image region (NO in step S51), it is judged whether or not the first region is an intermediate region (step S55). Here, the intermediate region is a non-image region sandwiched by two image regions in the sub scanning direction, and in the example shown in FIG. 8, the attribute region Z3 is an intermediate region.

While the attribute region Z3 is sandwiched by the partial region Z2 whose attribute is “thin line” (the first image region) and the partial region Z4 whose attribute is “solid” (the second image region), none of the partial regions Z1 and Z5 is sandwiched by two image regions. Thus it is determined that the partial regions Z1 and Z5 are not intermediate regions.

The reason why each non-image region is classified into an intermediate region and a non-intermediate region is to change the development condition depending on whether or not the non-image region is an intermediate region.

That is to say, as explained below, with regard to the non-image regions, control is performed basically as follows. That is to say, when a portion of the surface of the photosensitive drum 11Y corresponding to a non-image portion passes through the development position 18Y, the development bias voltage is turned OFF and the rotation of the developing roller 19Y is stopped.

However, in the case of an intermediate region sandwiched by a first image region and a second image region, the narrower the width of the intermediate region in the sub scanning direction is, the shorter the time taken by the portion of the surface of the photosensitive drum 11Y corresponding to the intermediate region to pass through the development position 18Y is. In that case, it becomes more and more difficult to, within the shorter time period, raise the development bias voltage from OFF to a regular voltage value and raise the developing roller 19Y from a stopped state to a regular rotational speed.

In view of this, with regard to the intermediate regions, the DC voltage of the development bias voltage is maintained to approximately half the standard value to reduce the time taken to raise the voltage to the standard voltage value, and at the same time, the rotational speed of the developing roller 19Y is maintained to approximately half the standard speed to reduce the time taken to raise the rotational speed to the standard rotational speed.

If it is judged that the first region is not an intermediate region (NO in step S55), the DC and AC of the development bias voltage are both set to OFF (step S56), and the control returns to the main routine.

On the other hand, if it is judged that the first region is an intermediate region (YES in step S55), the DC voltage of the development bias voltage is set to a voltage value Vb which is half the standard value Va, and the AC is set to OFF (step S57), and the control returns to the main routine.

This completes setting of the DC voltage value (including OFF), Vpp of the AC (including OFF) and the duty ratio D of the development bias voltage for the first partial region (partial region 1).

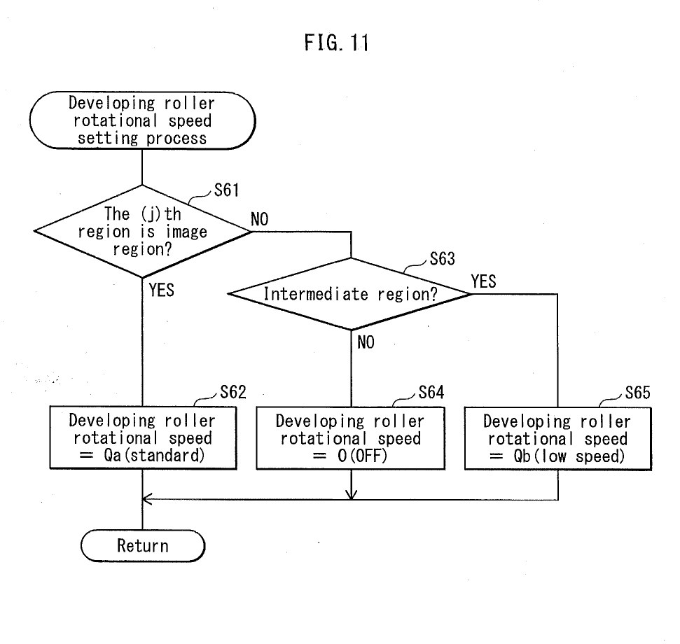

FIG. 11 is a flowchart of a subroutine to perform the developing roller rotational speed setting process (step S6).

As shown in FIG. 11, it is judged whether or not the j^{th} partial region, which is, in this example, the first partial region, is an image region (step S61). This judgment is performed in the same manner as step S51 described above.

If it is judged that the first partial region is an image region (YES in step S61), the rotational speed of the developing roller 19Y for the first partial region is set to a standard speed Qa (step S62), and the control returns to the main routine.

Here, the standard speed Qa is a speed corresponding to the system speed of the apparatus that is determined based on the rotational speed of the photosensitive drums 11Y-11K and the transportation speed of the recording sheets S. For both image regions having attributes “thin line” and “solid”, the rotational speed of the developing roller 19Y is set to the standard speed Qa.

If it is judged that the first partial region is not an image region (NO in step S61), it is judged whether or not the first partial region (non-image region) is an intermediate region (step S63). If it is judged that the first partial region is not an intermediate region (NO in step S63), the rotational speed of the developing roller 19Y for the first partial region is set to 0 (OFF) (step S64), and the control returns to the main routine.

On the other hand, if it is judged that the first partial region is an intermediate region (YES in step S63), the rotational speed of the developing roller 19Y for the first partial region is set to the speed Qb that is half the standard speed Qa (step S65), and the control returns to the main routine.

Back to FIG. 3, in step S7, it is judged whether or not the value of variable “j” is the last number. Here, the last number means the last number among the numbers assigned in steps S4.

If it is judged that the value of variable “j” is not the last number (NO in step S7), the current value of variable “j”, which is “1” in this example, is incremented by “1” to be set to “2” (step S8), and the control returns to step S5.

Subsequently, the development bias setting process in step S5 and the developing roller rotational speed setting process in step S6 are executed. This completes setting of the DC voltage value, Vpp, duty ratio D of the development bias voltage and the rotational speed of the developing roller 19Y for the partial region 2. The process of steps S5 and S6 is repeatedly executed, and the development conditions for the partial regions 1, 2, . . . are set in sequence until it is judged that the value of variable “j” is the last number.

FIG. 8 illustrates, in a table format, how development conditions suitable for each of the attributes (“thin line”, “solid”, “non-image”) are set for partial regions Z1-Z5, which are results of dividing the whole region of one page into partial regions in the sub scanning direction so that respective adjacent partial regions have different attributes. As indicated by this table, information that associates the coordinate positions (the front-end and rear-end positions) in one page region, attribute names, and development conditions (values for the respective attributes) with each other for each partial region is stored in a predetermined region of the image memory 106 as the setting information for the first page. The setting information is stored for each of the second and onward pages in a similar manner.

If it is judged that the value of variable “j” is the last number (YES in step S7), a completion of setting the development conditions for the first page is recognized, and the control moves to step S9 to judge whether or not the value of variable “n” is the last number. Here, the last number means the last number among the numbers assigned in steps S1. If it is judged that the value of variable “n” is not the last number (NO in step S9), the current value of variable “n”, which is “1” in this example, is incremented by “1” to be set to “2” (step S10), and the control returns to step S2.

In step S2 and onward, an image region detection process (step S2), an attribute region determination process (step S3), setting of development conditions for partial regions (steps S5, S6) and the like are executed based on the image data of the second page.

The process of steps S2-S10 is repeatedly executed, and the development conditions, which are suitable for the respective attributes of partial regions included in each of the pages 1, 2, . . . , are set in sequence until it is judged that the value of variable “n” is the last number.

If it is judged that the value of variable “n” is the last number (YES in step S9), a completion of setting the development conditions for all the pages included in the job is recognized, and the process is ended.

### (4) Control of Development Bias Voltage and Developing Roller Rotational Speed During Execution of Job

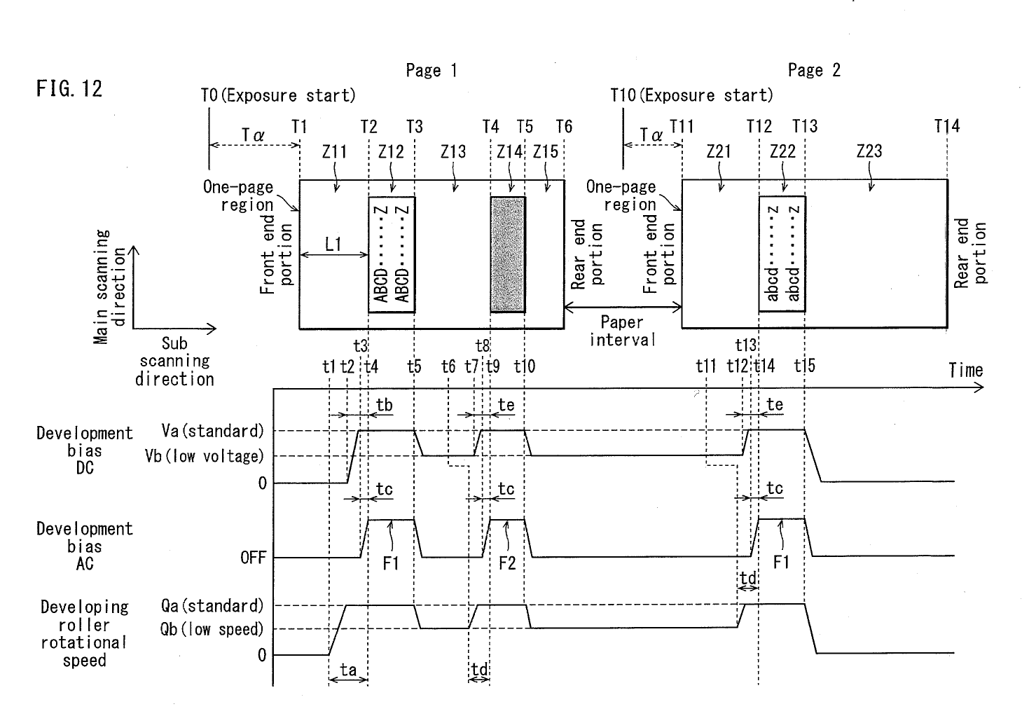

FIG. 12 is a timing chart illustrating how the controller 50 controls the development bias voltage and developing roller rotational speed for the color Y during an execution of a print job, taking, as one example, the case where printing of the first and second pages for the color Y is executed. Note that the DC voltage values “Va” and “Vb” of the development bias voltage are minus values.

FIG. 12 illustrates an example of the case where timings at which the development bias voltage is turned ON/OFF, timings at which the rotation of the developing roller 19Y is stopped/started, and the like, are determined with reference to times “T1” and “T11”, wherein “T1” and “T11” denote times at which the page front end of each of pages of electrostatic latent images formed on the photosensitive drum 11Y passes through the development position 18Y.

Let “T0” denote a time point at which an exposure-scan of the first page on the photosensitive drum 11Y is started, let “La” denote a distance from an exposure position on the circumferential surface of the photosensitive drum 11Y to the development position, and let “Va” denote a speed (drum circumferential speed) of the circumferential surface of the photosensitive drum 11Y, and the time point T1 is obtained as a time point after a time period Tα (=Lα/Vα) elapses from the exposure start time point T0. In this way, the time point T1 can be obtained by designating the exposure start time point T0 as the starting point. This also applies to the time point T11, and the time point T11 can be obtained as a time after the time period Tα elapses from a T10 at which an exposure-scan of the second page on the photosensitive drum 11Y is started.

The values of the distance Lα, drum circumferential speed Vα, and time period Tα are determined uniquely to the apparatus, are preliminarily stored in the ROM 108 or the like and can be obtained therefrom through reading.

The first page is divided into five regions: partial regions Z11, Z13 and Z15 whose attribute is “non-image”; a partial region Z12 whose attribute is “thin line”; and a partial region Z14 whose attribute is “solid”. The second page is divided into three regions: partial regions Z21 and Z23 whose attribute is “non-image”; and a partial region Z22 whose attribute is “thin line”. The signs T1-T6 and T11-T14 denote time points at which the front ends and the rear ends of the partial regions Z11-Z15 and Z21-Z23 pass through the development position 18Y. These time points can be obtained as follows.

That is to say, as one example, in the case of time point T2, let L1 denote a distance between the page front end and the front end of the partial region Z12 in the first page, let Tz denote a quotient obtained by dividing the distance L1 by the drum circumferential speed Vα, then the time point T2 corresponds to a time after the time period Tz elapses from a standard time point T1, and can be obtained when the distance L1 and the drum circumferential speed Va are known.

Here, a distance La can be obtained by converting the number of pixels, that are present in the region extending from the page front end to the front end of the partial region Z12 in the sub scanning direction, into the actual distance in the sub scanning direction on the circumferential surface of the photosensitive drum 11Y. The coordinate positions of the partial regions are obtained by reading the setting information of the first page from the image memory 106. The other time points such as time point T3 can be obtained in the same manner as the time point T2.

The controller 50, before executing printing of the image of the first page, reads the setting information from the image memory 106, and obtains (presumes) times of time points T1-T6 by designating the exposure start time point T0 of the first page as the start point, based on the coordinate positions (positions of the front end and the rear end) of the partial regions Z11-Z15 included in the first page.

The controller 50 then determines the timings for controlling the development bias voltage and the rotation of the developing roller 19Y based on the obtained time points T1-T6 and the development conditions for the first page included in the read setting information, and controls the development bias voltage and the rotation of the developing roller 19Y by using the determined timings.

Time points t1-t10, t11-t15 shown in FIG. 12 indicate the determined control timings. Note that the time point t4 matches the time point T2, the time point t5 matches the time point T3, the time point t9 matches the time point T4, the time point t10 matches the time point T5, the time point t14 matches the time point T12, and the time point t15 matches the time point T13.

At time point T1, the DC voltage of the development bias voltage is 0 V (OFF), the output of the AC component is OFF, and the developing roller 19Y has been stopped. In the following, the state where the DC voltage of the development bias voltage and the output of the AC component are OFF is called “output stop”, and the state where the development bias voltage is in “output stop” and the developing roller is stopped is called “complete stop”.

The reason why the “complete stop” is performed at time point T1 is that the partial region Z11 is a non-image region, not an intermediate region. It is possible to restrict the occurrence of a development fog by performing the complete stop while the partial region Z11 passes the development position 18Y. The reason is as follows.

That is to say, when an output of the development bias voltage for a non-image region is stopped, the action of the electric field onto the space between the developing roller 19Y and the photosensitive drum 11Y by the development bias voltage is eliminated. This makes it difficult, compared to the case where the development bias voltage is applied to generate the action by the electric field, for toner particles, which originally should not move from the developing roller 19Y to the photosensitive drum 11Y, to be affected by electric field and move and attach to a portion of the latent image on the photosensitive drum 11Y corresponding to the partial region Z11.

Also, when the rotation of the developing roller 19Y is stopped, the supply of toner, which is the developer, is stopped. As a result, compared to the case where the developing roller 19Y is rotated at the standard speed Qa to supply an enough amount of toner, it is possible to restrict the amount of toner particles that, among the toner particles carried by the surface of the developing roller 19Y, contact the surface of the photosensitive drum 11Y and, by the mechanical attachment force or the like that acts on the toner particles, move and attach to a portion of the latent image on the photosensitive drum 11Y corresponding to the partial region Z11.

At time point t1, the developing roller 19Y is started to rotate. The time point t1 is a time point that precedes time point T2 by a time period ta, wherein the time period ta is preliminarily obtained as a time period that is presumed to be taken for the rotation of the developing roller 19Y starting with the stopped state to reach the standard rotation speed Qa to be stable, by taking into account the variation in the conveyance of the drive force of the drive unit 70Y and the like.

With this structure, the rotation of the developing roller 19Y has been stabilized at the standard rotation speed Qa before the front end of the partial region Z12, which is an image region, reaches the development position 18Y.

Similarly, when time point t2, which precedes time point T2, is reached, the output of the DC voltage of the development bias voltage is started. The time point t2 is a time point that precedes time point T2 by a time period tb, wherein the time period tb is preliminarily obtained as a time period that is presumed to be taken for the DC voltage of the development bias voltage, from the start of the output, to rise and reach the standard value Va.

Similarly, when time point t3, which precedes time point T2, is reached, the output of the AC of the development bias voltage is started. The time point t3 is a time point that precedes time point T2 by a time period tc, wherein the time period tc is preliminarily obtained as a time period that is presumed to be taken for the AC of the development bias voltage, from the start of the output, to become stable.

With the above structure, at time point T2 when the front end of the partial region Z12, which is an image region, reaches the development position 18Y, the DC voltage and the AC component of the development bias voltage have risen to the standard values.

During a time period between time points T2 and T3, namely, while the partial region Z12 is passing through the development position, the DC voltage value of the development bias voltage is maintained to the standard value Va, and at the same time, the rotational speed of the developing roller 19Y is maintained to the standard value Qa, and the waveform of the AC component of the development bias voltage is controlled to be the waveform F1 (FIG. 10) that is suitable for the partial region Z12 having the attribute “thin line”. With the above operation, a development bias voltage having an AC waveform suitable for the attribute “thin line” is supplied to an image of thin lines (in this example, mainly a character image). This restricts the occurrence of the development fog and improves the reproducibility of the character image.

Note that, usually, the time periods ta-tc have a relationship in terms of length: tc<tb<ta. However, the relationship may change depending on the structure of the apparatus. Also, when the time periods ta-tc are as small as can be neglected, the time periods ta-tc may be set to “0”. In this case, the time points t1-t3 match the time point T2 (=t4).

As described above, with regard to an image region (in this example, image region Z12) that is to reach the development position 18Y first in the sub scanning direction among the regions included in one page, the time point T2 when the front end of the partial region Z12 is to pass through the development position 18Y is designated as the start point, and the time points t1-t3 at which the output of the development bias voltage and the rotation of the developing roller 19Y are started are determined as the time points that precede the time point T2 by time periods ta-tc that are preliminarily determined by taking into account the voltage rise time and the like.

When time point t5 (=T3) is reached, with a recognition that the rear end of the attribute region Z12, which is an image region, has passed through the development position 18Y, a control is performed so that the DC voltage of the development bias voltage is decreased from the standard value Va to a smaller value Vb, the output of the AC is stopped, and the rotational speed of the developing roller 19Y is decreased from the standard speed Qa to a lower speed Qb.

The reason why the DC voltage of the development bias voltage and the rotation of the developing roller 19Y are not stopped but maintained to low values is that the partial region Z13 that is to pass through the development position 18Y immediately after the partial region Z12 has attribute “non-image” and is an intermediate region.

Since the intermediate region indicates that it is followed by the image region Z14, it is necessary to return the values to the standard values before time point T4, when the front end of the next image region Z14 is to reach the development position 18Y, is reached. However, if the DC voltage of the development bias voltage and the rotation of the developing roller 19Y are completely stopped, as described above, it takes time relatively for the values to rise to the standard values. Thus, if it is recognized that the next region is an intermediate region, these operations are not stopped, but the values are maintained to low values to reduce the rise time.

Here, the output of the AC component of the development bias voltage is stopped even if the next region is an intermediate region. This is because it takes only a short time before the AC component becomes stable.

With the above structure, the DC voltage value of the development bias voltage is maintained to the value Vb that is lower than the standard value Va, the output of the AC component of the development bias voltage is stopped, and the rotational speed of the developing roller 19Y is maintained to the speed Qb that is slower than the standard speed Qa.

Note that, when the DC voltage value of the development bias voltage and the rotational speed of the developing roller 19Y are maintained to the values that are smaller than the respective standard values, the development fog is easier to occur than in the case of “complete stop” such as the time period between time points T1 and T2, but the occurrence of the development fog can be restricted at least more than in the case of the conventional structure in which the standard values are maintained. Although to what extent the voltage value and the rotational speed should be reduced from the standard values is determined based on the structure of the apparatus as appropriate, the voltage value and the rotational speed are preferably as close to the standard values as possible within the range where human eyes cannot detect the presence of the development fog. Even if the next region is an intermediate region, the “complete stop” may be performed when it hardly takes time for the values to rise to the standard values.

When time point t6, which precedes time point T4 (=t9), is reached, a control is performed so that the rotational speed of the developing roller 19Y is increased from the low speed Qb to the standard speed Qa.

The time point t6 is a time point that precedes time point T4 by a time period td, wherein the time period td is preliminarily obtained as a time period that is presumed to be taken for the rotation of the developing roller 19Y to rise from the low speed Qb to the standard speed Qa and become stable at the standard speed Qa. With this structure, the rotation of the developing roller 19Y has been stabilized at the standard rotation speed Qa before time point T4 at which the front end of the partial region Z14, which is an image region, reaches the development position 18Y.

Similarly, when time point t7, which precedes time point T4, is reached, a control is performed so that the DC voltage of the development bias voltage is increased from Vb to standard value Va. The time point t7 is a time point that precedes time point T4 by a time period te, wherein the time period te is preliminarily obtained as a time period that is presumed to be taken for the DC voltage of the development bias voltage to rise from Vb to the standard value Va.

Also, when time point t8, which precedes time point T4, is reached, the output of the AC of the development bias voltage is started. The time point t8 is a time point that precedes time point T4 by a time period tc, wherein the time period tc is equal to the above-described time period tc.

With the above structure, at time point T4 when the front end of the partial region Z14, which is an image region, reaches the development position 18Y, the DC component and the AC component of the development bias voltage have risen to the standard values.

During a time period between time points T4 and T5, namely, while the partial region Z14 having the attribute “solid” is passing through the development position, a control is performed so that the DC voltage value of the development bias voltage is maintained to the standard value Va, the rotational speed of the developing roller 19Y is maintained to the standard value Qa, and the waveform of the AC component of the development bias voltage is controlled to be the waveform F2 (FIG. 10) that is suitable for the partial region Z14 having the attribute “solid”.

With the above operation, a development bias voltage having an AC waveform suitable for the attribute “solid” is supplied to a solid image (in this example, mainly a halftone image). This restricts the occurrence of the development fog and improves the reproducibility of the halftone image.

When time point T5 (=t10) is reached, with a recognition that the rear end of the partial region Z14, which is an image region, has passed through the development position 18Y, a control is performed so that the DC voltage of the development bias voltage is decreased from the standard value Va to a smaller value Vb, the output of the AC is stopped, and the rotational speed of the developing roller 19Y is decreased from the standard speed Qa to a lower speed Qb.

This control is the same as that performed at time points t5-t6. The reason why the above control is performed is that the printing does not end with the first page, but printing of the second page is scheduled to be performed. That is to say, if the printing is to end with the first page, the control would be switched to the “complete stop” at the time point T5 (=t10) because the partial region Z15 is a non-image region. However, if the printing of the first page is followed by a printing of the second page, the output of the development bias voltage and the rotation of the developing roller 19Y are completely stopped with the “complete stop” at the time point T5 and then, immediately after this, they may be re-started. Accordingly, taking into account the time period that is taken for the rising, the DC voltage of the development bias voltage and the rotational speed of the developing roller 19Y are maintained to values that are smaller than the standard values.

As explained above, the partial region Z15, which is a non-image region placed at the most rear end of the first page, is judged to be an intermediate region only if the first page is continuously followed by the second page (YES in step S55, YES in step S63). Also, in association with this, the partial region Z21, which is a non-image region placed at the most front end of the second page, is judged to be an intermediate region.

That is to say, a partial region which is a non-image region placed at the most rear end of an n page and a partial region which is a non-image region placed at the most front end of an (n+1) page are judged as intermediate regions when the n page and the (n+1) page are to be printed continuously.

A time period after the development process for the image of the first page is ended and before the development process for the image of the second page is started, namely, a time period between time points T6 and T11, is what is called a paper interval. The front end of the second page reaches the development position 18Y at time point T11, after the time period Tα elapses from the exposure start time point T10 in printing of the second page.

As shown in FIG. 12, the second page includes a partial region Z21 (a non-image region), a partial region Z22 (an image region having attribute “thin line”), and a partial region Z23 (a non-image region), in order from the front end to the rear end.

When time point t11, which precedes time point T12 (=t14) at which the front end of the partial region Z22 (an image region) is to reach the development position 18Y, is reached, a control is performed so that the rotational speed of the developing roller 19Y is increased from the low speed Qb to the standard speed Qa. The time point t11 is a time point that precedes time point T12 by a time period td. The time point td is equal to the above-described time period td. With this structure, the rotation of the developing roller 19Y has been stabilized at the standard rotation speed Qa before time point T12 at which the front end of the partial region Z22, which is an image region, reaches the development position 18Y.

Similarly, when time point t12, which precedes time point T12, is reached, a control is performed so that the DC voltage of the development bias voltage is increased from Vb to standard value Va. The time point t12 is a time point that precedes time point T12 by a time period te, wherein the time period te is equal to the above-described time period te.

Also, when time point t13, which precedes time point T12, is reached, the output of the AC of the development bias voltage is started. The time point t13 is a time point that precedes time point T12 by a time period tc, wherein the time period tc is equal to the above-described time period tc. At this time, the output of the AC component of the development bias voltage is controlled to be the waveform F1 that is suitable for the attribute “thin line”.

With the above structure, at time point T12 when the front end of the partial region Z22, which is an image region, reaches the development position 18Y, the DC component and the AC component of the development bias voltage have risen to the standard values.

When time point T13 (=t15) is reached, with a recognition that the rear end of the partial region Z22, which is an image region, has passed through the development position 18Y, the “complete stop” is performed. Here, the occurrence of the development fog in a non-image region can be restricted by stopping the output of the development bias voltage and the rotation of the developing roller 19Y since the partial region Z23 is a non-image region, but not an intermediate region.

Note that, although it has been described so far that a control is performed for the color Y so that the development conditions are changed depending on the attribute of each partial region, the same control is performed for each of the other colors, M, C and K.

### (5) Evaluation Results of Control Over Development Bias Voltage and Rotational Speed of Developing Roller

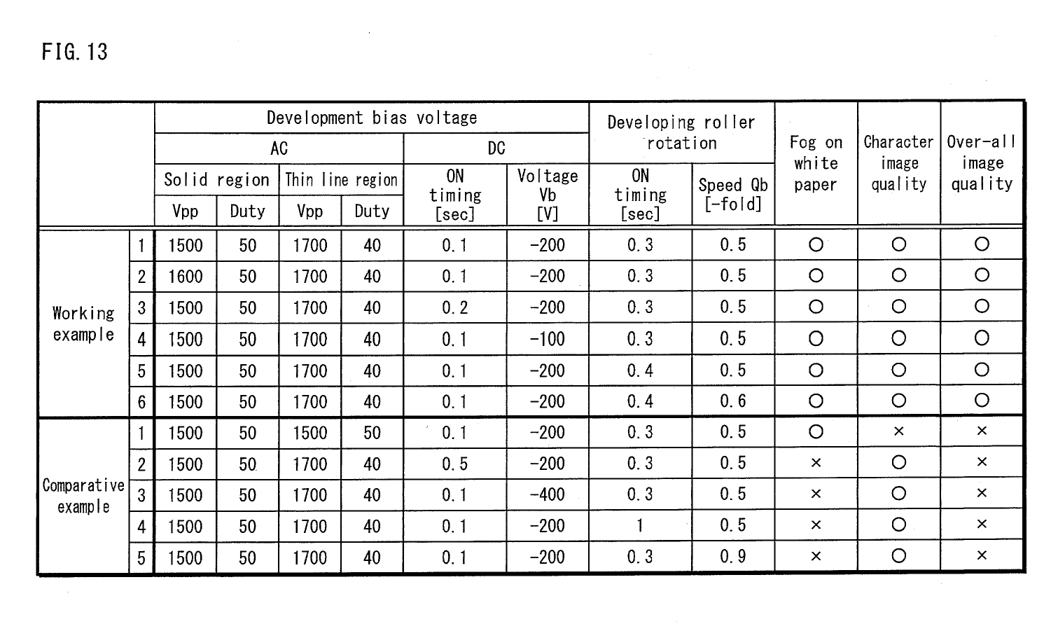

FIG. 13 illustrates an example of results of evaluation of reproduced images obtained through an experiment of execution of a print job in apparatuses in which a program for performing a control to change the development conditions in units of partial regions had been embedded.

In this experiment, a program for performing the above control was embedded in “bizhub C652DS” manufactured by KONICA MINOLTA, and the CF paper manufactured by KONICA MINOLTA was used as the recording sheet. The experiment was conducted in an environment of temperature 23° C. and humidity 65%.

As shown in FIG. 13, the experiment was conducted by varying the development conditions: Vpp and duty ratio of the AC of the development bias voltage; the timing of turning ON the DC of the development bias voltage; the voltage Vb; the timing of turning ON the developing roller 19Y; and the rotational speed Qb, on both the working examples and comparative examples, and the results of evaluation concerning fog on white paper and image quality of characters are shown.

As to the fog on white paper, it was visually judged whether or not toner particles were present on a white paper portion (an original portion on which the toner should not be present) of the recording sheet on which the printing had been made by the print job, and sign “o” was provided when the present of toner particles was not visually confirmed, and sign “x” was provided when the present of toner particles was visually confirmed. Also, as to the character image quality, sign “o” was provided when it was visually judged that the density of characters had been reproduced excellently, and sign “x” was provided when it was visually judged that the density of characters was low and had not been reproduced excellently. As to the over-all image quality, sign “o” was provided when both the fog on white paper and character image quality were evaluated as “o”, sign “x” was provided when at least one of the fog on white paper and character image quality was evaluated as “x”.

The working example 1 sets the basis for the development conditions. Based on the development conditions set in the working example 1, development conditions of the other examples were varied as follows; in the working example 2, Vpp for the “solid” regions was varied; in the working example 3, the timing of turning ON the DC of the development bias voltage was varied; in the working example 4, the DC voltage Vb of the development bias voltage was varied; in the working example 5, the timing of turning ON the developing roller 19Y was varied; and in the working example 6, the timing of turning ON the developing roller 19Y and the rotational speed Qb of the developing roller 19Y were varied.

Also, based on the development conditions set in the working example 1, development conditions of the comparative examples were varied as follows; in the comparative example 1, Vpp and duty ratio for the “thin line” regions were varied; in the comparative example 2, the timing of turning ON the DC of the development bias voltage was varied; in the comparative example 3, the DC voltage Vb of the development bias voltage was varied; in the comparative example 4, the timing of turning ON the developing roller 19Y was varied; and in the comparative example 5, the rotational speed Qb of the developing roller 19Y was varied.

The working examples 1-6 were evaluated as “o” in the over-all image quality. This indicates that experiment apparatuses meeting the development conditions in the range of working examples 1-6 can improve both the fog in white paper and character image quality. On the other hand, comparative examples 1-5 were evaluated as “x” in the over-all image quality since either the fog on white paper or the character image quality was evaluated as “x”.

For example, in the case of comparative example 1, Vpp for the “thin line” regions is smaller than that in working example 1, and the duty ratio for the “thin line” regions is higher than that in working example 1. This is considered to be because, as described above, since the width of the latent image portion on the photosensitive drum 11 corresponding to the “thin line” region is thin, if Vpp is excessively small, it becomes difficult for toner particles to attach to the latent image portion having the thin width and the density of the “thin line” region is apt to decrease, and on the other hand, if the duty ratio is excessively high, an excessive amount of toner is supplied to the “thin line” region, and the thin lines are apt to become thicker than original, and as a result, the character image quality of comparative example 1 was degraded.

Similarly, in the case of comparative example 2, the value indicated in the column of the timing of turning ON the DC voltage of the development bias voltage is greater than that in working example 1. This value corresponds to the length of the time period tb shown in FIG. 12. Thus the greater this value is, the longer the time period tb is and the earlier the timing for starting output of the DC voltage of the development bias voltage is.

This is considered as follows. That is to say, originally, the output of the DC voltage of the development bias voltage to non-image regions should be stopped. On the contrary, in the case of comparative example 2, the output of the DC voltage of the development bias voltage was started at an earlier timing and the DC voltage of the development bias voltage was output for a longer time period, which made it easier for the development fog to occur, and as a result, comparative example 2 was evaluated as “x” in the fog in white paper.

In the case of comparative example 3, the value of the DC voltage Vb of the development bias voltage is greater in absolute value than that in working example 1. The DC voltage Vb corresponds to the voltage Vb shown in FIG. 12, and is a voltage that is output while a non-image region (doubling as an intermediate region) is passing through the development position 18Y. The greater the voltage Vb in absolute value is, the stronger the action of the electric field that causes the toner particles carried by the developing roller 19Y to move toward the photosensitive drum 11Y is. It is considered that this made it easy for the development fog to occur in the non-image region, and comparative example 3 was evaluated as “x” in the fog in white paper.

In the case of comparative example 4, the value indicated in the column of the timing of turning ON the developing roller 19Y is greater than that in working example 1. This value corresponds to the length of the time period ta shown in FIG. 12. Thus the greater this value is, the longer the time period ta is and the earlier the timing for starting the developing roller 19Y to rotate is.

This is considered as follows. That is to say, originally, the rotation of the developing roller 19Y should be stopped for non-image regions. On the contrary, in the case of comparative example 4, the rotation of the developing roller 19Y was started at an earlier timing and the developing roller 19Y was rotated for a longer time period, which made it easier for the development fog to occur, and as a result, comparative example 4 was evaluated as “x” in the fog in white paper.

In the case of comparative example 5, the value of the ratio of the rotational speed Qb of the developing roller 19Y to the standard speed Qa is greater than that in working example 1. The rotational speed Qb corresponds to the rotational speed (low speed) Qb shown in FIG. 12. The higher this ratio is, the higher the rotational speed Qb of the developing roller 19Y for the non-image region (doubling as an intermediate region) is.

This is considered as follows. That is to say, originally, the rotation of the developing roller 19Y should be maintained to a low speed for the non-image region (doubling as an intermediate region). On the contrary, in the case of comparative example 5, the rotational speed Qb of the developing roller 19Y was too close to the standard speed Qa, which made it easier for the development fog to occur, and as a result, comparative example 5 was evaluated as “x” in the fog in white paper.

It is confirmed from the above results of the experiment that the control of the present embodiment for changing the development conditions provides an improvement in image quality in the practical apparatuses. Note that, although the experiment for image quality evaluation was conducted only for color Y and not for the other colors M-K, it is presumed that the same evaluation results are obtained for the other colors M-K as well since the basic structure of the apparatus is the same as for color Y.

As explained above, in the present embodiment, the control is performed to, for each of the partial regions of different attributes (thin line, solid, and non-image) that are present in the page at positions not overlapping with each other in the sub-scanning direction, switch the development conditions to those suitable for the attribute. This structure makes it possible to, for example, restrict the occurrence of the development fog in the non-image regions and improve the image quality by stopping the output of the development bias voltage and the rotation of the developing roller 19Y for the non-image regions.

The present invention is not limited to the image forming apparatus, but may be an image forming method for performing a control to change the development conditions. Also, the method may be realized as a program to be executed by a computer. Programs of the present invention may be recorded in any of various computer-readable recording mediums such as magnetic tape, magnetic disk like flexible disk, optical recording medium like DVD-ROM, DVD RAM, CD-ROM, CD-R, MO, and PD, and recording medium like flash memory, and the recording mediums with these programs recorded therein may be manufactured and distributed, and the programs may be transported and supplied via any of various types of wired or wireless networks such as the Internet, broadcast, electric communication line, and/or satellite communication. Furthermore, the processing described in the above embodiment may be performed by software, or may be performed by using a hardware circuit.

### <Modifications>

Up to now, the present invention has been described specifically through embodiments. However, the present invention is not limited to the above-described embodiments, but may be modified variously as in the following.

(1) In the above embodiment, the development conditions are the DC voltage value of the development bias voltage, Vpp and duty ratio D of the AC, and the rotational speed of the developing roller 19Y. However, not limited to these, at least one of these may be the development condition. For example, when the rotational speed of the developing roller 19Y is the development condition, the rotational speed may be set to “0” (stop) for non-image regions, and may be set to the standard speed Qa for image regions.

Also, when the DC voltage value of the development bias voltage is the development condition, for example, the DC voltage value for non-image regions may be set to be as smaller as possible in absolute value than the DC voltage value for image regions. This is because, the smaller the DC voltage value in absolute value, the larger the electric field acting in a direction for restricting the toner particles of the minus polarity from moving from the developing roller 19Y toward the photosensitive drum 11Y (a direction for drawing the toner particles toward the developing roller 19Y) relative to the minus potential in the non-image regions on the photosensitive drum 11Y. This restricts the toner particles from attaching to the non-image regions.

Also, when the duty ratio D is the development condition, for example, the duty ratio for non-image regions may be set to be as lower as possible than the duty ratio for image regions. The reason is as follows. When the duty ratio is made lower, in one cycle of the AC, the time period during which the voltage is on the plus side compared to the ground (GND: 0V) becomes longer. In other words, the time period (corresponding to the above-described “Ta”) during which the electric field acting in a direction for restricting the toner particles of the minus polarity from moving from the developing roller 19Y toward the photosensitive drum 11Y (a direction for drawing the toner particles toward the developing roller 19Y) is generated is longer than the time period (corresponding to the above-described “Tb”) during which the electric field acting in the opposite direction is generated. This makes it easier to restrict the toner particles from moving from the developing roller 19Y toward the photosensitive drum 11Y and attaching to the non-image regions thereon.

Also, when Vpp is the development condition, for example, Vpp for non-image regions may be set to be as smaller as possible than Vpp for image regions. This is because, when Vpp is made smaller without changing the cycle of the AC, the waveform of the AC becomes closer to the waveform of the DC, the movement of the toner particles between the developing roller 19Y and the photosensitive drum 11Y is more restricted, and due to the minus potential of the non-image regions on the photosensitive drum 11Y, it becomes more difficult for the toner particles of the minus polarity from moving from the developing roller 19Y toward the photosensitive drum 11Y, and thus the toner particles are restricted from attaching to the non-image regions.

In the above embodiment, both the output of the development bias voltage and the rotation of the developing roller 19Y are stopped for the non-image regions (that are not intermediate regions). However, there is a case where the occurrence of the development fog can be restricted to some extent if these values for the non-image regions are set to be smaller than the standard values for the image regions. Accordingly, in such a case, not limited to the structure of the embodiment, these values for the non-image regions may be set to be smaller than the standard values for the image regions.

(2) In the above embodiment, based on the image data of one page, the first and second partial regions of different attributes, which are present in the page at positions not overlapping with each other in the sub-scanning direction, are determined, and the partial regions targeted in this determination are three types of attribute regions: non-image region; image (thin line) region; and image (solid) region. However, not limited to this, regions of other attributes may be targeted in the determination. Also, among the three types of attribute regions, two types of attribute regions may be targeted in the determination.

In the above embodiment, the attribute of image is classified into “thin line” and “solid”. However, not limited to this, the attribute of image may be classified into “thin line” and other.

Furthermore, for example, a thin line may be segmented into a plurality of sections depending on the size of the width, and Vpp may be made greater and the duty ratio may be made lower for sections with smaller width in the thin line. With this structure, it is possible to set different development conditions more accurately depending on the size of the width of the thin line. This can further improve the image quality of the reproduced image.

Furthermore, similarly, a “solid” region may be segmented into a plurality of sections of different levels of density, and Vpp may be made greater and the duty ratio may be made lower for sections with lower density. In this case, Vpp for the “solid” regions is set to be smaller than Vpp for the “thin line” regions, and the duty ratio for the “solid” regions is set to be higher than the duty ratio for the “thin line” regions. With this structure, when the line width and density are classified more minutely, the stepwise segmentation becomes closer to a linear segmentation, and it is possible to perform a control based on a linear-proportional relationship between (i) the line width and the density value and (ii) Vpp and the duty ratio.

(3) In the above embodiment, the printed area ratio α is used to judge whether or not a character line in a determined character region is a thin line. However, the present invention is not limited to this. Any method may be adopted as far as it is possible for the development bias voltage value and the rotational speed of the developing roller to be switched between values for “thin line” attribute and values for other attributes. For example, received data of a print job may include information concerning the character line width. With this structure, it is possible to judge, from the comparison result between the line width indicated by the information and a threshold value for the judgment on line width, whether or not a character line is a thin line.

Also, in the above embodiment, character regions and photo regions are detected based on the image data of one page. However, this detection is not required if received data of a print job includes information that identifies attributes of character regions and photo regions in one page, and information that indicates the coordinate positions of the regions. In this case, the attribute region determination process can be performed to determine two or more regions that have different attributes and are present in one page at positions not overlapping with each other in the sub-scanning direction.

(4) In the above embodiment, the image forming apparatus of the present invention is applied to a tandem color digital printer. However, the present invention is not limited to this structure. The present invention is applicable to any image forming apparatus regardless of whether for color image formation or for monochrome image formation, such as a copier, a facsimile apparatus, or an MFP (Multiple Function Peripheral), that is structured to apply a development bias voltage, which is composed of a DC component and an AC component, the AC component superimposed on the DC component, to a rotating developer carrier, and develop an electrostatic latent image, which is formed on an image carrier, at a development position on the image carrier by using developer carried by the developer carrier.

Also, the image carrier, on which the electrostatic latent image is formed, is not limited to the photosensitive drum, nor to a drum-like shape, but may have a shape of a belt, for example. In the above embodiment, a developing roller is used as the developer carrier that carries developer. However, not limited to a roller-like shape, the developer carrier may have a shape of a sleeve, for example. In the above embodiment, two-component developer containing carrier and toner is used as the developer. However, not limited to two-component developer, the present invention is applicable to one-component developer containing toner without carrier.

Furthermore, although in the above embodiment, toner having minus polarity is used, the present invention is also applicable to, for example, a developing method that uses toner having plus polarity. In this case, the DC voltage of the development bias voltage and the like have polarities that are contrary to those described above.

Also, the present invention may be any combination of the above embodiment and modifications.

### CONCLUSION

The above embodiment and modifications show one aspect for solving the problem explained in the “RELATED ART” section. The above embodiment and modifications can be summarized as follows.

(1) An image forming apparatus to expose-scan an electrically charged surface of an image carrier in accordance with image data in unit of page to form an electrostatic latent image on the image carrier, and develop the electrostatic latent image at a development position on the image carrier by using developer carried by a developer carrier, the image forming apparatus comprising: a drive unit driving the developer carrier to rotate; a power source supplying a development bias voltage including a DC component and an AC component to the developer carrier; a determination unit determining, in accordance with image data of a page, a first partial region having a first attribute and a second partial region having a second attribute, the first and second partial regions being included in the page and not overlapping with each other in a sub scanning direction; and a controller switching at least one of a development bias voltage value and a rotational speed of the developer carrier to a value for the first attribute while a portion of an electrostatic latent image of the page formed on the image carrier corresponding to the first partial region passes through a development position, and to a value for the second attribute while a portion of the electrostatic latent image of the page formed on the image carrier corresponding to the second partial region passes through the development position, the value for the first attribute and the value for the second attribute being different values.

(2) The image forming apparatus of (1), wherein the first partial region is an image region, the first attribute being a thin line attribute indicating that the image regions include images of thin lines, the second partial region is an image region, the second attribute being an attribute other than the thin line attribute, the controller controls at least one of a peak-to-peak voltage and a duty ratio, wherein, in a state where the AC component is superimposed on the DC component, a unit waveform in one cycle T is divided by a voltage value of the DC component into a first potential portion whose potential, in absolute value, is closer to a ground and a second potential portion whose potential, in absolute value, is farther away from the ground, a difference between the first potential portion and the second potential portion in peak voltage is the peak-to-peak voltage, a time period of the first potential portion in the one cycle T is denoted by Ta, a time period of the second potential portion in the one cycle T is denoted by Tb, and a quotient obtained by dividing the time period Tb by the cycle T is the duty ratio, a value of the peak-to-peak voltage for the first attribute is greater than a value of the peak-to-peak voltage for the second attribute, and a value of the duty ratio for the second attribute is greater than a value of the duty ratio for the first attribute.

(3) The image forming apparatus of (1), wherein the first partial region is an image region, the second partial region is a non-image region, the controller controls a voltage value of the DC component in the development bias voltage, the values for the first attribute and the second attribute are voltage values of the DC component, and the value for the second attribute is smaller in absolute value than the value for the first attribute.

(4) The image forming apparatus of (1), wherein the first partial region is an image region, the second partial region is a non-image region, the controller controls the rotational speed of the developer carrier, the values for the first attribute and the second attribute are rotational speeds of the developer carrier, and the value for the second attribute is smaller than the value for the first attribute.

(5) The image forming apparatus of (4), wherein the value for the second attribute is zero.

(6) The image forming apparatus of (4), wherein when a first non-image region and a second non-image region are present in one page, the first non-image region being sandwiched by two adjacent image regions in the sub scanning direction, and the second non-image region not being sandwiched by two adjacent image regions, the controller sets values for the second attribute such that a value for the second non-image region is smaller than a value for the first non-image region.

(7) The image forming apparatus of (2), wherein the first partial region is an image region, the second partial region is a non-image region, the controller controls the rotational speed of the developer carrier, the values for the first attribute and the second attribute are rotational speeds of the developer carrier, and the value for the second attribute is smaller than the value for the first attribute.

(8) The image forming apparatus of (7), wherein the value for the second attribute is zero.

(9) The image forming apparatus of (7), wherein when a first non-image region and a second non-image region are present in one page, the first non-image region being sandwiched by two adjacent image regions in the sub scanning direction, and the second non-image region not being sandwiched by two adjacent image regions, the controller sets values for the second attribute such that a value for the second non-image region is smaller than a value for the first non-image region.

(10) An image forming method for an image forming apparatus to expose-scan an electrically charged surface of an image carrier in accordance with image data in unit of page to form an electrostatic latent image on the image carrier, and develop the electrostatic latent image at a development position on the image carrier by using developer carried by a developer carrier, the image forming method comprising the steps of: determining, in accordance with image data of a page, a first partial region having a first attribute and a second partial region having a second attribute, the first and second partial regions being included in the page and not overlapping with each other in a sub scanning direction; and controlling to switch at least one of a development bias voltage value and a rotational speed of the developer carrier to a value for the first attribute while a portion of an electrostatic latent image of the page formed on the image carrier corresponding to the first partial region passes through a development position, and to a value for the second attribute while a portion of the electrostatic latent image of the page formed on the image carrier corresponding to the second partial region passes through the development position, the value for the first attribute and the value for the second attribute being different values.

(11) The image forming method of (10), wherein the first partial region is an image region, the first attribute being a thin line attribute indicating that the image regions include images of thin lines, the second partial region is an image region, the second attribute being an attribute other than the thin line attribute, the controlling step controls at least one of a peak-to-peak voltage and a duty ratio, wherein, in a state where the AC component is superimposed on the DC component, a unit waveform in one cycle T is divided by a voltage value of the DC component into a first potential portion whose potential, in absolute value, is closer to a ground and a second potential portion whose potential, in absolute value, is farther away from the ground, a difference between the first potential portion and the second potential portion in peak voltage is the peak-to-peak voltage, a time period of the first potential portion in the one cycle T is denoted by Ta, a time period of the second potential portion in the one cycle T is denoted by Tb, and a quotient obtained by dividing the time period Tb by the cycle T is the duty ratio, a value of the peak-to-peak voltage for the first attribute is greater than a value of the peak-to-peak voltage for the second attribute, and a value of the duty ratio for the second attribute is greater than a value of the duty ratio for the first attribute.

(12) The image forming method of (10), wherein the first partial region is an image region, the second partial region is a non-image region, the controlling step controls a voltage value of the DC component in the development bias voltage, the values for the first attribute and the second attribute are voltage values of the DC component, and the value for the second attribute is smaller in absolute value than the value for the first attribute.

(13) The image forming method of (10), wherein the first partial region is an image region, the second partial region is a non-image region, the controlling step controls the rotational speed of the developer carrier, the values for the first attribute and the second attribute are rotational speeds of the developer carrier, and the value for the second attribute is smaller than the value for the first attribute.

(14) The image forming method of (13), wherein the value for the second attribute is zero.

(15) The image forming method of (13), wherein when a first non-image region and a second non-image region are present in one page, the first non-image region being sandwiched by two adjacent image regions in the sub scanning direction, and the second non-image region not being sandwiched by two adjacent image regions, the controlling step sets values for the second attribute such that a value for the second non-image region is smaller than a value for the first non-image region.

(16) The image forming method of (11), wherein the first partial region is an image region, the second partial region is a non-image region, the controlling step controls the rotational speed of the developer carrier, the values for the first attribute and the second attribute are rotational speeds of the developer carrier, and the value for the second attribute is smaller than the value for the first attribute.

(17) The image forming method of (16), wherein the value for the second attribute is zero.

(18) The image forming method of (16), wherein when a first non-image region and a second non-image region are present in one page, the first non-image region being sandwiched by two adjacent image regions in the sub scanning direction, and the second non-image region not being sandwiched by two adjacent image regions, the controlling step sets values for the second attribute such that a value for the second non-image region is smaller than a value for the first non-image region.

With the above-described structure in which at least one of the development bias voltage value and the rotational speed of the developer carrier is switched to a value for an attribute of the determined partial region, if the attribute of the partial region is determined as, for example, “non-image”, it is possible to set at least one of the development bias voltage value and the rotational speed of the developer carrier to a value that is for the non-image region, thereby preventing the occurrence of the development fog and contributing to the improvement in image quality of the reproduced image.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image forming apparatus to expose-scan an electrically charged surface of an image carrier in accordance with image data in unit of page to form an electrostatic latent image on the image carrier, and develop the electrostatic latent image at a development position on the image carrier by using developer carried by a developer carrier, the image forming apparatus comprising:
a drive unit driving the developer carrier to rotate;
a power source supplying a development bias voltage including a DC component and an AC component to the developer carrier;
a determination unit determining, in accordance with image data of a page, a first partial region having a first attribute and a second partial region having a second attribute, the first and second partial regions being included in the page and not overlapping with each other in a sub scanning direction; and
a controller switching at least one of a development bias voltage value and a rotational speed of the developer carrier to a value for the first attribute while a portion of an electrostatic latent image of the page formed on the image carrier corresponding to the first partial region passes through a development position, and to a value for the second attribute while a portion of the electrostatic latent image of the page formed on the image carrier corresponding to the second partial region passes through the development position, the value for the first attribute and the value for the second attribute being different values.

2. The image forming apparatus of claim 1, wherein
the first partial region is an image region, the first attribute being a thin line attribute indicating that the image regions include images of thin lines,
the second partial region is an image region, the second attribute being an attribute other than the thin line attribute,
the controller controls at least one of a peak-to-peak voltage and a duty ratio, wherein, in a state where the AC component is superimposed on the DC component, a unit waveform in one cycle T is divided by a voltage value of the DC component into a first potential portion whose potential, in absolute value, is closer to a ground and a second potential portion whose potential, in absolute value, is farther away from the ground, a difference between the first potential portion and the second potential portion in peak voltage is the peak-to-peak voltage, a time period of the first potential portion in the one cycle T is denoted by Ta, a time period of the second potential portion in the one cycle T is denoted by Tb, and a quotient obtained by dividing the time period Tb by the cycle T is the duty ratio,
a value of the peak-to-peak voltage for the first attribute is greater than a value of the peak-to-peak voltage for the second attribute, and
a value of the duty ratio for the second attribute is greater than a value of the duty ratio for the first attribute.

3. The image forming apparatus of claim 1, wherein
the first partial region is an image region,
the second partial region is a non-image region,
the controller controls a voltage value of the DC component in the development bias voltage,
the values for the first attribute and the second attribute are voltage values of the DC component, and
the value for the second attribute is smaller in absolute value than the value for the first attribute.

4. The image forming apparatus of claim 1, wherein
the first partial region is an image region,
the second partial region is a non-image region,
the controller controls the rotational speed of the developer carrier,
the values for the first attribute and the second attribute are rotational speeds of the developer carrier, and
the value for the second attribute is smaller than the value for the first attribute.

5. The image forming apparatus of claim 4, wherein
the value for the second attribute is zero.

6. The image forming apparatus of claim 4, wherein
when a first non-image region and a second non-image region are present in one page, the first non-image region being sandwiched by two adjacent image regions in the sub scanning direction, and the second non-image region not being sandwiched by two adjacent image regions,
the controller sets values for the second attribute such that a value for the second non-image region is smaller than a value for the first non-image region.

7. The image forming apparatus of claim 2, wherein
the first partial region is an image region,
the second partial region is a non-image region,
the controller controls the rotational speed of the developer carrier,
the values for the first attribute and the second attribute are rotational speeds of the developer carrier, and
the value for the second attribute is smaller than the value for the first attribute.

8. The image forming apparatus of claim 7, wherein
the value for the second attribute is zero.

9. The image forming apparatus of claim 7, wherein
when a first non-image region and a second non-image region are present in one page, the first non-image region being sandwiched by two adjacent image regions in the sub scanning direction, and the second non-image region not being sandwiched by two adjacent image regions,
the controller sets values for the second attribute such that a value for the second non-image region is smaller than a value for the first non-image region.

10. An image forming method for an image forming apparatus to expose-scan an electrically charged surface of an image carrier in accordance with image data in unit of page to form an electrostatic latent image on the image carrier, and develop the electrostatic latent image at a development position on the image carrier by using developer carried by a developer carrier, the image forming method comprising the steps of:
determining, in accordance with image data of a page, a first partial region having a first attribute and a second partial region having a second attribute, the first and second partial regions being included in the page and not overlapping with each other in a sub scanning direction; and
controlling to switch at least one of a development bias voltage value and a rotational speed of the developer carrier to a value for the first attribute while a portion of an electrostatic latent image of the page formed on the image carrier corresponding to the first partial region passes through a development position, and to a value for the second attribute while a portion of the electrostatic latent image of the page formed on the image carrier corresponding to the second partial region passes through the development position, the value for the first attribute and the value for the second attribute being different values.

11. The image forming method of claim 10, wherein
the first partial region is an image region, the first attribute being a thin line attribute indicating that the image regions include images of thin lines,
the second partial region is an image region, the second attribute being an attribute other than the thin line attribute,
the controlling step controls at least one of a peak-to-peak voltage and a duty ratio, wherein, in a state where the AC component is superimposed on the DC component, a unit waveform in one cycle T is divided by a voltage value of the DC component into a first potential portion whose potential, in absolute value, is closer to a ground and a second potential portion whose potential, in absolute value, is farther away from the ground, a difference between the first potential portion and the second potential portion in peak voltage is the peak-to-peak voltage, a time period of the first potential portion in the one cycle T is denoted by Ta, a time period of the second potential portion in the one cycle T is denoted by Tb, and a quotient obtained by dividing the time period Tb by the cycle T is the duty ratio,
a value of the peak-to-peak voltage for the first attribute is greater than a value of the peak-to-peak voltage for the second attribute, and
a value of the duty ratio for the second attribute is greater than a value of the duty ratio for the first attribute.

12. The image forming method of claim 10, wherein
the first partial region is an image region,
the second partial region is a non-image region,
the controlling step controls a voltage value of the DC component in the development bias voltage,
the values for the first attribute and the second attribute are voltage values of the DC component, and
the value for the second attribute is smaller in absolute value than the value for the first attribute.

13. The image forming method of claim 10, wherein
the first partial region is an image region,
the second partial region is a non-image region,
the controlling step controls the rotational speed of the developer carrier,
the values for the first attribute and the second attribute are rotational speeds of the developer carrier, and
the value for the second attribute is smaller than the value for the first attribute.

14. The image forming method of claim 13, wherein
the value for the second attribute is zero.

15. The image forming method of claim 13, wherein
when a first non-image region and a second non-image region are present in one page, the first non-image region being sandwiched by two adjacent image regions in the sub scanning direction, and the second non-image region not being sandwiched by two adjacent image regions,
the controlling step sets values for the second attribute such that a value for the second non-image region is smaller than a value for the first non-image region.

16. The image forming method of claim 11, wherein
the first partial region is an image region,
the second partial region is a non-image region,
the controlling step controls the rotational speed of the developer carrier,
the values for the first attribute and the second attribute are rotational speeds of the developer carrier, and
the value for the second attribute is smaller than the value for the first attribute.

17. The image forming method of claim 16, wherein
the value for the second attribute is zero.

18. The image forming method of claim 16, wherein
when a first non-image region and a second non-image region are present in one page, the first non-image region being sandwiched by two adjacent image regions in the sub scanning direction, and the second non-image region not being sandwiched by two adjacent image regions,
the controlling step sets values for the second attribute such that a value for the second non-image region is smaller than a value for the first non-image region.
